(19) United States
(12) Patent Application Publication
(10) Pub. No.: US 2026/0264434 A1
(43) Pub. Date: Sep. 10, 2026

(54) SYSTEM, USAGE ASSISTANCE METHOD, AND SERVER

(71) Applicant: SEIKO EPSON CORPORATION, Tokyo (JP)

(72) Inventors: Atsushi TOYOFUKU, SHIOJIRI-SHI (JP); Nobuaki ITO, SUWA-SHI (JP)

(21) Appl. No.: 19/554,924

(22) Filed: Mar. 3, 2026

(30) Foreign Application Priority Data
Mar. 6, 2025 (JP) 2025-035416

(51) Int. Cl. B41J 29/393; B41J 2/175; B41J 2/195; G06K 15/00; G06K 15/10

(52) U.S. Cl. CPC B41J 29/393; B41J 2/17566; B41J 2/195; G06K 15/007; G06K 15/102; G06K 15/407; B41J 2002/17569; B41J 2002/17589

(57) ABSTRACT

A system used to eject ink using an ink jet head includes an acceptance section that accepts usage condition information indicating a usage condition relating to ejection of ink, based on operation information by a specific user, and a recommendation section that recommends, based on history information indicating a history of use by a user different from the specific user and the usage condition information, to the specific user, as recommendation information, a usage condition different from the usage condition indicated by the usage condition information accepted by the acceptance section.

The present application is based on, and claims priority from JP Application Serial Number 2025-035416, filed Mar. 6, 2025, the disclosure of which is hereby incorporated by reference herein in its entirety.

### BACKGROUND

### 1. Technical Field

The present disclosure relates to a system, a usage assistance method, and a server.

### 2. Related Art

In the related art, an ink jet printer including an ink jet head that ejects a liquid such as ink is known. For example, JP-A-2021-115725 discloses a method of determining a drive waveform to be applied to an ink jet head by application of an automatic algorithm. In addition, JP-A-2023-60470 discloses a system that stores, in advance, correspondence information regarding a correspondence relationship between usage conditions such as a type of ink and drive waveforms, and that, based on the correspondence information, provides a user with waveform information indicating a drive waveform corresponding to usage conditions, such as the type of ink, input by the user.

In a system that recommends information regarding use of an ink jet head, it is required to recommend recommendation information indicating usage conditions suitable for usage condition information input by a user. However, in the technique of JP-A-2021-115725, although recommendation information based on the usage condition information can be recommended to the user, the recommendation information determined by the automatic algorithm is not necessarily preferable for the user, that is, the quality of the recommendation information may deteriorate. Meanwhile, in the technique of JP-A-2023-60470, when the correspondence information includes the same information as the usage condition information, high-quality recommendation information can be provided to the user. However, since the kinds of information included in the usage condition information and the kinds of recommendation information are enormous, the correspondence relationship between the usage condition information and the recommendation information also becomes enormous, and constructing the correspondence information is difficult. As described above, even when provision of high-quality recommendation information is to be maintained, it is difficult to facilitate construction of information indicating the correspondence relationship between the usage condition information and the recommendation information.

### SUMMARY

According to a preferred aspect of the present disclosure, there is provided a system used to eject ink using an ink jet head, the system including: an acceptance section that accepts usage condition information indicating a usage condition relating to ejection of ink, based on operation information by a specific user; and a recommendation section that recommends, based on history information indicating a history of use by a user different from the specific user and the usage condition information, to the specific user, as recommendation information, a usage condition different from the usage condition indicated by the usage condition information accepted by the acceptance section.

According to another preferred aspect of the present disclosure, there is provided a usage assistance method for a system used to eject ink using an ink jet head, the usage assistance method including: an acceptance step of accepting usage condition information indicating a usage condition relating to ejection of ink, based on operation information by a specific user; and a recommendation step of recommending, based on history information indicating a history of use by a user different from the specific user and the usage condition information, to the specific user, as recommendation information, a usage condition different from the usage condition indicated by the usage condition information accepted in the acceptance step.

According to still another preferred aspect of the present disclosure, there is provided a server for use in a system used to eject ink using an ink jet head, the server including: an acquisition section that acquires usage condition information indicating a usage condition of a specific user relating to ejection of ink; a search section that searches, based on history information indicating a history of use by a user different from the specific user and the usage condition information, for recommendation information for recommending to the specific user a usage condition different from the usage condition indicated by the usage condition information; and an output section that outputs the recommendation information.

### BRIEF DESCRIPTION OF THE DRAWINGS

FIG. 1 is a schematic diagram illustrating an ink jet printer.

FIG. 2 is a schematic diagram showing a configuration example of a system according to a first embodiment.

FIG. 3 is a diagram showing an example of a configuration of a server.

FIG. 4 is a diagram showing a configuration of an evaluation apparatus.

FIG. 5 is a diagram showing functions of the system.

FIG. 6 is a diagram showing an example of contents of correspondence information.

FIG. 7 is a diagram showing an example of a drive waveform indicated by waveform information.

FIG. 8 is a diagram showing contents of an ink table.

FIG. 9 is a diagram showing a flowchart showing operations of the system.

FIG. 10 is a diagram showing an example of an input screen.

FIG. 11 is a diagram showing a flowchart showing an operation of a search process.

FIG. 12 is a diagram showing a flowchart showing an input-ink and derived-head setting process.

FIG. 13 is a diagram illustrating processing in step SC28.

FIG. 14 is a diagram illustrating processing in step SC28.

FIG. 15 is a diagram illustrating a process of setting a derived head.

FIG. 16 is a diagram illustrating a generation example of recommendation information.

FIG. 17 is a diagram illustrating a generation example of the recommendation information.

FIG. 18 is a diagram showing a flowchart showing an input-ink and derived-head setting process in a first modification example.

FIG. 19 is a diagram illustrating a generation example of recommendation information in the first modification example.

FIG. 20 is a diagram showing a flowchart showing an input-ink and derived-head setting process in a second modification example.

FIG. 21 is a diagram illustrating processing in step SC28b.

FIG. 22 is a diagram showing an example of an image processing parameter.

### DESCRIPTION OF EMBODIMENTS

Hereinafter, embodiments for carrying out the present disclosure are described with reference to the drawings. It should be noted that, in each drawing, dimensions and scales of each portion are made different, as appropriate, from actual ones. Additionally, since the embodiments to be described below are preferred specific examples of the present disclosure, various technically preferred limitations are applied; however, unless the following description specifically states that the present disclosure is limited, the scope of the present disclosure is not limited to these embodiments.

### 1. First Embodiment

A system SYS according to a first embodiment provides a service that assists in the use of an ink jet head HU by recommending, to a user U who uses the ink jet head HU, an appropriate usage condition relating to ejection of ink, when the user U manufactures an ink jet printer 10 that ejects ink using the ink jet head HU. Therefore, in the present specification, first, the ink jet printer 10 will be described, and next, the system SYS will be described.

### 1-1. Overview of Ink Jet Printer 10

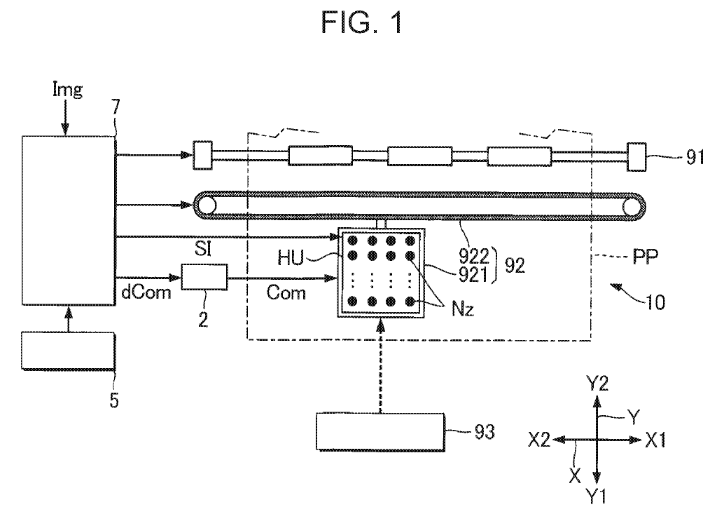

FIG. 1 is a schematic diagram illustrating the ink jet printer 10. The ink jet printer 10 is an ink jet type printing apparatus that ejects ink, which is an example of a liquid, onto a medium PP. The medium PP is typically printing paper; however, any print target such as a resin film or a woven fabric can be utilized as the medium PP.

As illustrated in FIG. 1, the ink jet printer 10 includes a liquid container 93 that stores ink. As the liquid container 93, for example, a cartridge attachable to and detachable from the ink jet printer 10, a bag-shaped ink pack formed of a flexible film, an ink tank into which ink can be replenished, or the like can be employed. A plurality of types of ink differing in color are stored in the liquid container 93.

As illustrated in FIG. 1, the ink jet printer 10 includes a drive signal generation circuit 2, the ink jet head HU, a control section 7, a storage section 5, a moving mechanism 91, and a transport mechanism 92. The ink jet head HU ejects ink toward the medium PP from one or more nozzles Nz.

The control section 7 is, for example, a processing circuit, such as a CPU or an FPGA. Here, CPU is an abbreviation for "central processing unit", and FPGA is an abbreviation for "field-programmable gate array". The control section 7 controls each element of the ink jet printer 10.

The storage section 5 includes a volatile memory such as RAM and a non-volatile memory such as ROM, EEPROM, or PROM, and stores various kinds of information such as print data Img supplied from a host computer and a control program of the ink jet printer 10. RAM is an abbreviation for "random access memory". ROM is an abbreviation for "read-only memory". EEPROM is an abbreviation for "electrically erasable programmable read-only memory". PROM is an abbreviation for "programmable ROM".

Under the control of the control section 7, the moving mechanism 91 transports the medium PP in a Y1 direction along a Y-axis. Hereinafter, the Y1 direction and a Y2 direction opposite to the Y1 direction are collectively referred to as a direction along the Y-axis. In addition, hereinafter, an X1 direction along the X-axis intersecting the Y-axis and an X2 direction opposite to the X1 direction are collectively referred to as a direction along the X-axis. Further, hereinafter, a Z1 direction along a Z-axis intersecting the X-axis and the Y-axis and a Z2 direction opposite to the Z1 direction are collectively referred to as a direction along the Z-axis. In the present embodiment, as an example, the X-axis, the Y-axis, and the Z-axis are assumed to be orthogonal to each other for description. However, the present disclosure is not limited to such an aspect. The X-axis, the Y-axis, and the Z-axis need only intersect each other.

Under the control of the control section 7, the transport mechanism 92 reciprocates the ink jet head HU in the X1 direction and the X2 direction. As shown in FIG. 1, the transport mechanism 92 includes a storage case 921 that houses the ink jet head HU and an endless belt 922 to which the storage case 921 is fixed. The liquid container 93 may be stored in the storage case 921 together with the ink jet head HU.

The control section 7 controls an ejection operation of the ink jet head HU. Specifically, the control section 7 generates a printing signal SI for controlling the ink jet head HU, a waveform designation signal dCom for controlling the drive signal generation circuit 2, a signal for controlling the transport mechanism 92, and a signal for controlling the moving mechanism 91.

The waveform designation signal dCom is a digital signal for defining a waveform of a drive signal Com. Additionally, the drive signal Com is an analog signal for driving the ink jet head HU. The drive signal generation circuit 2 includes a D/A conversion circuit and generates the drive signal Com having the waveform defined by the waveform designation signal dCom.

In addition, the printing signal SI is a digital signal for designating a type of operation of the ink jet head HU. Specifically, the printing signal SI is a signal for designating whether or not to eject ink from each of one or more nozzles Nz by designating whether or not to supply the drive signal Com to the ink jet head HU.

The control section 7 first stores the print data Img supplied from the host computer in the storage section 5. Next, the control section 7 generates various control signals such as the printing signal SI, the waveform designation signal dCom, the signal for controlling the transport mechanism 92, and the signal for controlling the moving mechanism 91, based on various pieces of data such as the print data Img stored in the storage section 5. Then, the control section 7 controls the ink jet head HU based on the various control signals and the various pieces of data stored in the storage section 5, while controlling the transport mechanism 92 and the moving mechanism 91 to change a relative position of the medium PP with respect to the ink jet head HU. As a result, the control section 7 controls execution of image processing of forming, on the medium PP, an image corresponding to the print data Img.

### 1-2. Overview of System SYS

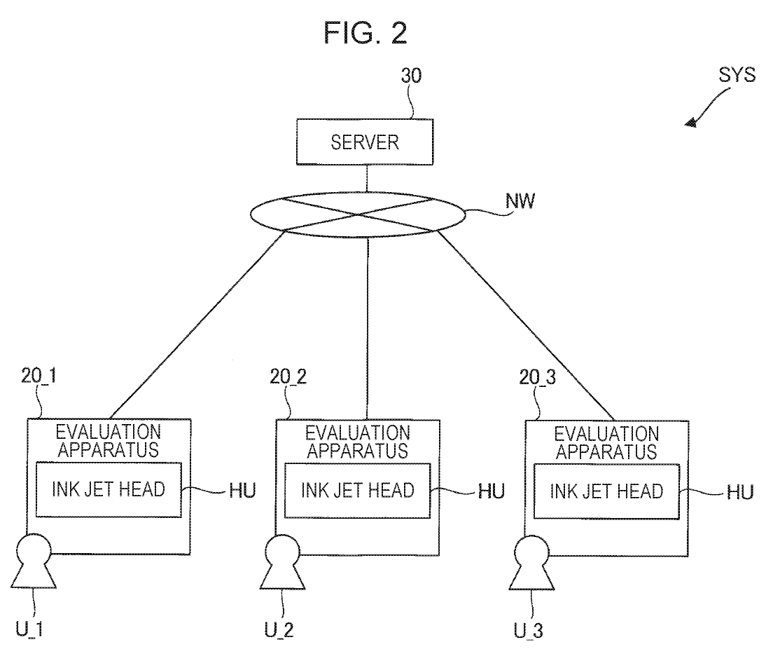

FIG. 2 is a schematic diagram showing a configuration example of the system SYS according to the first embodiment. As described above, the system SYS provides a service that recommends a usage condition relating to ejection of ink. The system SYS includes evaluation apparatuses 20_1 to 20_3 and a server 30. Instead of the evaluation apparatuses 20_1 to 20_3 of the users U, a processing apparatus (a PC, a smartphone, or the like) of the user may be connected to the server 30. PC is an abbreviation for "personal computer".

The evaluation apparatuses 20_1 to 20_3 are apparatuses that evaluate the ink jet head HU. In the following description, each of the evaluation apparatuses 20_1 to 20_3 may be collectively referred to, without distinction, as an evaluation apparatus 20. For example, as a function of evaluating the ink jet head HU, the evaluation apparatuses 20_1 to 20_3 have, for example, a function of observing an ejection state of ink droplets ejected from the ink jet head HU and a function of observing how ink droplets land on the medium PP.

The user U who uses the evaluation apparatus 20 is a vendor that manufactures the ink jet printer 10. Hereinafter, the user U who uses the evaluation apparatus 20 may be referred to as a "printer manufacturer". Meanwhile, a vendor that manufactures the ink jet head HU and the evaluation apparatus 20 may be referred to as a "head manufacturer". The printer manufacturer acquires the evaluation apparatus 20 from the head manufacturer and evaluates the ink jet head HU using the evaluation apparatus 20 such that an image formed on the medium PP by the ink jet printer 10 satisfies conditions desired by the printer manufacturer.

In the example of FIG. 2, one evaluation apparatus 20 includes one ink jet head HU. However, the number of ink jet heads HU that one evaluation apparatus 20 includes is not limited to one, and one evaluation apparatus 20 may include two or more ink jet heads HU.

FIG. 2 shows a user U_1 who uses the evaluation apparatus 20_1, a user U_2 who uses the evaluation apparatus 20_2, and a user U_3 who uses the evaluation apparatus 20_3. In the following description, the users U_1 to U_3 may be collectively referred to, without distinction, as a user U.

In the example shown in FIG. 2, the system SYS includes three evaluation apparatuses 20; however, the number of evaluation apparatuses 20 that the system SYS includes is not limited to three and may be one, two, or four or more.

The server 30 is a computer that functions as a cloud server CS, which will be described below. The head manufacturer utilizes a part of the server 30. The evaluation apparatus 20 is communicably connected to the server 30 via a network NW such as a LAN, a WAN, and the Internet. LAN is an abbreviation for "local area network". WAN is an abbreviation for "wide area network".

### 1-3. Configuration of Server 30

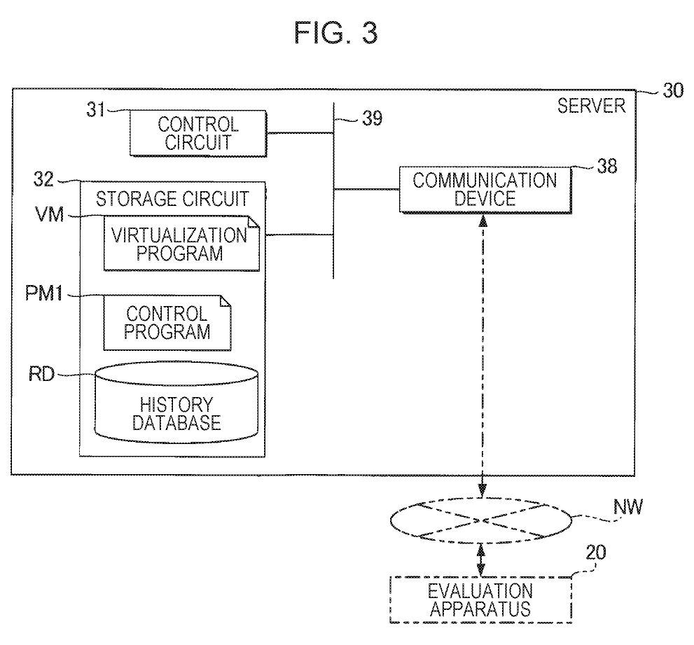

FIG. 3 is a diagram showing an example of a configuration of the server 30. The server 30 includes a control circuit 31, a storage circuit 32, and a communication device 38. The control circuit 31, the storage circuit 32, and the communication device 38 are mutually connected via a bus 39 for information communication.

The control circuit 31 includes, for example, one or more processors such as a CPU. CPU is an abbreviation for "central processing unit". The control circuit 31 may include, in place of or in addition to the CPU, a programmable logic device such as an FPGA. FPGA is an abbreviation for "field-programmable gate array".

The storage circuit 32 is configured with a magnetic storage device, a flash ROM, or the like. The storage circuit 32 is readable by the control circuit 31 and stores a plurality of programs including a virtualization program VM and a control program PM1 executed by the control circuit 31, a history database RD, various kinds of information used by the control circuit 31, and the like. The virtualization program VM divides resources such as the control circuit 31 and the storage circuit 32 of the server 30 into a plurality of parts and causes each divided resource to operate as the cloud server CS. The head manufacturer utilizes, as a part of the server 30, some of a plurality of cloud servers CS. The control program PM1 is developed by the head manufacturer. The control program PM1 and the history database RD are used to implement a service provided by the system SYS.

However, the storage circuit 32 need not include the virtualization program VM, and the evaluation apparatus 20 may access the server 30 instead of the cloud server CS.

The storage circuit 32 includes, for example, semiconductor memories of one or both of one or more volatile memories, such as RAM, and one or more non-volatile memories, such as ROM, EEPROM, or PROM. RAM is an abbreviation for "random access memory". ROM is an abbreviation for "read-only memory". EEPROM is an abbreviation for "electrically erasable programmable read-only memory". PROM is an abbreviation for "programmable ROM".

The communication device 38 is hardware including a communication circuit for communicating with the evaluation apparatus 20 via the network NW. The communication device 38 is also referred to, for example, as a network device, a network controller, a network card, or a communication module.

### 1-4. Configuration of Evaluation Apparatus 20

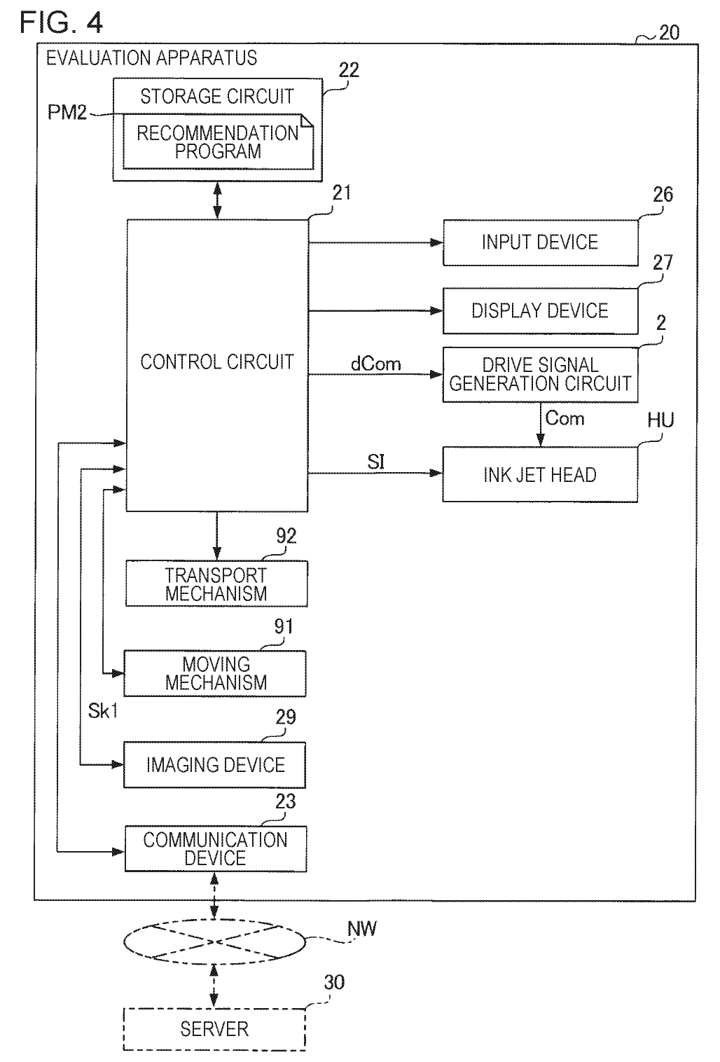

FIG. 4 is a diagram showing a configuration of the evaluation apparatus 20. The evaluation apparatus 20 includes a control circuit 21, a storage circuit 22, a communication device 23, an input device 26, a display device 27, the moving mechanism 91, the transport mechanism 92, the drive signal generation circuit 2, the ink jet head HU, and an imaging device 29.

The control circuit 21 includes, for example, one or more processors such as a CPU. The control circuit 21 may include, in place of or in addition to the CPU, a programmable logic device such as an FPGA.

The storage circuit 22 is configured with a magnetic storage device, a flash ROM, or the like. The storage circuit 22 is readable by the control circuit 21 and stores a plurality of programs including a recommendation program PM2 executed by the control circuit 21, and various kinds of information used by the control circuit 21. The storage circuit 22 includes, for example, semiconductor memories of one or both of one or more volatile memories, such as RAM, and one or more non-volatile memories, such as ROM, EEPROM, or PROM. The recommendation program PM2 may be preinstalled in, for example, the evaluation apparatus 20, or, when the evaluation apparatus 20 is initially connected to the server 30, may be downloaded from the cloud server CS operating on the server 30 and installed in the evaluation apparatus 20.

The communication device 23 is hardware including a communication circuit for communicating with the server 30 via the network NW. The communication device 23 is also referred to, for example, as a network device, a network controller, a network card, or a communication module.

The input device 26 is a device that outputs operation information corresponding to an operation of the user U. The input device 26 is, for example, a mouse and a keyboard.

The display device 27 displays an image indicating some kind of information to the user U. The display device 27 is an organic EL display, an LED display, and an LCD. EL is an abbreviation for "electro-luminescence". LED is an abbreviation for "light-emitting diode". LCD is an abbreviation for "liquid crystal display". Additionally, the input device 26 and the display device 27 may be configured integrally. A configuration in which the input device 26 and the display device 27 are formed integrally is, for example, a touch panel.

Since the moving mechanism 91, the transport mechanism 92, the drive signal generation circuit 2, and the ink jet head HU provided in the evaluation apparatus 20 have the same functions as the moving mechanism 91, the transport mechanism 92, the drive signal generation circuit 2, and the ink jet head HU provided in the ink jet printer 10 shown in FIG. 1, the description thereof will not be repeated.

The imaging device 29 images ink droplets ejected from the ink jet head HU. Specifically, the imaging device 29 includes, for example, an imaging optical system and an imaging element. The imaging optical system is an optical system including at least one imaging lens and may include various optical elements such as a prism, or may include a zoom lens, a focus lens, or the like. The imaging element is, for example, a CCD image sensor, a CMOS image sensor, or the like. CCD is an abbreviation for "charge-coupled device". CMOS is an abbreviation for "complementary MOS".

In order to implement a part of the functions of the evaluation apparatus 20 described above, namely a function of observing the ejection state of ink droplets ejected from the ink jet head HU and a function of observing how ink droplets land on the medium PP, the control circuit 21 transmits an imaging instruction Sk1 to the imaging device 29, transmits the printing signal SI to the ink jet head HU, and transmits the waveform designation signal dCom to the drive signal generation circuit 2. The imaging device 29 transmits to the control circuit 21 image information indicating an image in which one or both of ink droplets in flight and ink droplets landed on the medium PP are captured.

### 1-5. History Database RD

In the service provided by the system SYS, it is required to recommend a usage condition relating to the ejection of ink that is suitable for the usage condition information JI input by the user U. Hereinafter, information indicating the usage condition recommended by the system SYS may be referred to as "recommendation information RI". The recommendation information RI has item values corresponding to one or more items relating to the ejection of ink. The one or more items relating to the ejection of ink are, for example, one or a plurality of items such as a type of ink, a physical property of the ink, and an ejection characteristic of the ink jet head HU. The ejection characteristic is, for example, one or both of an ejection amount and an ejection speed. The usage condition information JI also has values of one or more items relating to the ejection of ink. Hereinafter, the one or more items relating to the ejection of ink may be simply referred to as "items" and the values of the one or more items relating to the ejection of ink may be referred to as "item values". Additionally, the item value included in the usage condition information JI may be referred to as an "input item value". Further, the item value included in the recommendation information RI may be referred to as a "recommended item value".

As a method of determining the recommendation information RI, for example, a method is conceivable in which the usage condition relating to the ejection of ink is determined by application of an automatic algorithm. However, in this method, although the usage condition based on the usage condition information JI can be recommended to the user U, processing time by the automatic algorithm becomes excessive, and the recommendation information RI determined by the automatic algorithm is not necessarily preferable to the user U, that is, there are cases where the quality of the recommendation information RI deteriorates. In addition, another method is conceivable in which a correspondence relationship between the input item values included in the usage condition information JI and waveform information indicating the drive waveform, which can be one of the recommended item values, is stored in the history database RD, and waveform information corresponding to the usage condition information JI input by the user U is recommend based on the history database RD. The drive signal Com has the drive waveform indicated by the waveform information. In this method, when the history database RD includes the same information as the usage condition information JI input by the user U, waveform information preferable to the user U can be recommended to the user U, that is, high-quality recommendation information RI can be provided. However, when a type of ink unknown to the head manufacturer is designated in the usage condition information JI, waveform information preferable to the user U cannot be recommended. Although the head manufacturer can provide, by performing experiments and the like each time, appropriate waveform information with appropriate compensation of the results, both the usage condition information JI and the waveform information are extremely diverse, and an excessive number of experiments is required. Therefore, it is practically difficult to construct the history database RD such that waveform information preferable to the user U can be recommended. As described above, even when high-quality recommendation information RI is to be maintained, it is difficult to facilitate construction of the history database RD.

Therefore, the system SYS in the present embodiment stores a record having a plurality of item values in the history database RD, searches for a record having appropriate item values according to the item values included in the usage condition information JI, sets one or more item values included in the retrieved record as the recommended item values, and provides to the user U recommendation information RI having the recommended item values.

### 1-6. Functions and Operation of System SYS

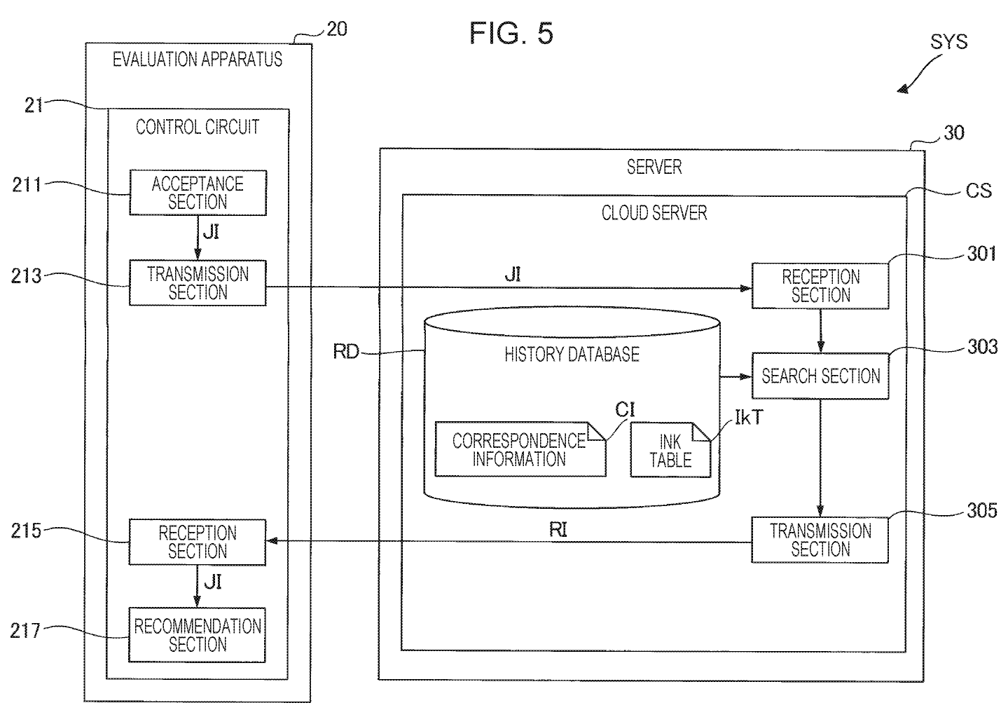

FIG. 5 is a diagram showing functions of the system SYS. The control circuit 21 reads out the recommendation program PM2 and, by executing the read-out recommendation program PM2, functions as an acceptance section 211, a transmission section 213, a reception section 215, and a recommendation section 217. The server 30 reads out the virtualization program VM and, by executing the read-out virtualization program VM, functions as the cloud server CS. The cloud server CS reads out the control program PM1 and, by executing the control program PM1, functions as a reception section 301, a search section 303, and a transmission section 305.

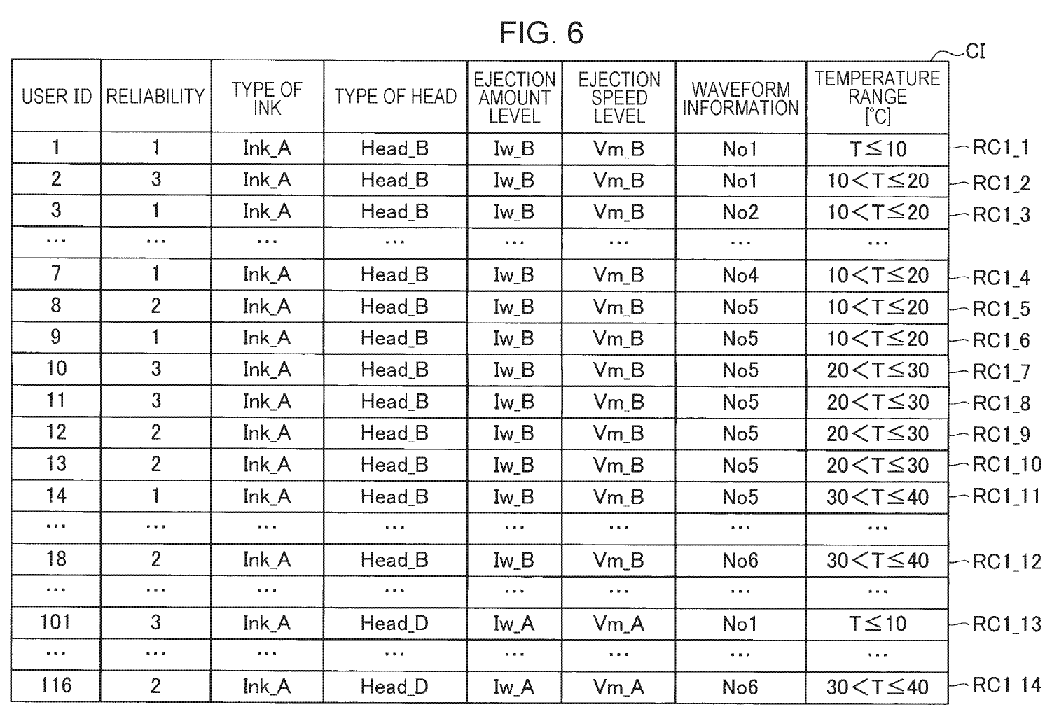

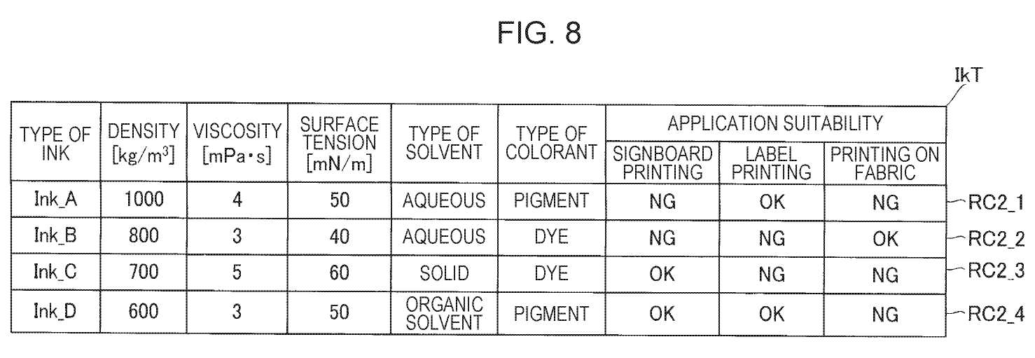

The history database RD is accessible from the evaluation apparatus 20 provided in the system SYS and from a computer not shown in FIG. 1. As shown in FIG. 5, the history database RD includes correspondence information CI and an ink table IkT. The correspondence information CI will be described with reference to FIG. 6, and the ink table IkT will be described with reference to FIG. 8.

FIG. 6 is a diagram showing an example of contents of the correspondence information CI. The correspondence information CI includes one or more records RC1 having: a numerical value indicating a user ID, a numerical value indicating reliability, a character string indicating a type of ink, a character string indicating a type of head, a character string indicating an ejection amount level, a character string indicating an ejection speed level, a character string for identifying waveform information, and a character string indicating a temperature range. The correspondence information CI shown in FIG. 6 includes records RC1_1 to RC1_14. Hereinafter, the records included in the correspondence information CI may be collectively referred to, without distinction, as the record RC1.

The type of ink, the type of head, the ejection amount level, the ejection speed level, the drive waveform indicated by the waveform information, and the temperature range correspond to "one or more items relating to ejection of ink". The character string indicating the type of ink corresponds to an "item value" corresponding to the type of ink corresponding to an "item relating to the ejection of ink". Similarly, the character string indicating the ejection amount level corresponds to an "item value" corresponding to the ejection amount level. The character string indicating the ejection speed level corresponds to an "item value" corresponding to the ejection speed level. The character string indicating the type of drive waveform corresponds to an "item value" corresponding to the drive waveform. The character string indicating the temperature range corresponds to an "item value" corresponding to the temperature range.

The record RC1 shown in FIG. 6 has all of the item values shown in FIG. 6, but may have only a part of the item values.

The numerical value indicating the user ID is a numerical value for uniquely identifying the user U, and indicates the user U using the ink jet head HU as indicated by an item value of one record RC1. In order to simplify the description, the user U using the ink jet head HU as indicated by the item value of one record RC1 may be referred to as a registered user Ur. The numerical value indicating the user ID can also be said to be a numerical value for identifying the registered user Ur. In the example of FIG. 6, different numerical values are set for the records RC1_1 to RC1_14, but two or more records RC1 having a numerical value indicating the same user U may be present. In addition, the numerical value indicating the user ID may include a numerical value indicating the head manufacturer. The record RC1 having the numerical value indicating the head manufacturer indicates that the record is registered by the head manufacturer in the correspondence information CI. Hereinafter, the head manufacturer will be described as one of the users of the system SYS.

The numerical value indicating reliability is a numerical value indicating a degree of reliability of the registered user Ur. In the example shown in FIG. 6, a higher numerical value indicates a higher degree of reliability. For example, a usage history of the ink jet head HU of a registered user Ur with high reliability is shorter than a usage history of the ink jet head HU of a registered user Ur with low reliability. It can be said that a record RC1 registered by a registered user Ur with high reliability tends to be higher in quality than a record RC1 registered by a registered user Ur with low reliability. In other words, the reliability can also be said to indicate a degree of quality of the record RC1. The numerical value indicating reliability is set, for example, by the head manufacturer evaluating the registered user Ur as appropriate. Alternatively, the system SYS may have a function of enabling, when the evaluation apparatus 20 accesses the correspondence information CI by an operation of the user U, high ratings to be set for each record RC1 included in the correspondence information CI. The numerical value indicating reliability may be set according to the number of high ratings set for each record RC1.

The character string indicating the type of ink is a character string for uniquely identifying ink used by the ink jet head HU used by the registered user Ur. The character string indicating the type of ink is, for example, an ink name. In the present specification, in order to simplify the description, the character string indicating the type of ink is indicated as "Ink_x". Herein, x is any single character.

The character string indicating the type of head is a character string for uniquely identifying the ink jet head HU used by the registered user Ur. In the present specification, in order to simplify the description, the character string indicating the type of head is indicated as "Head_x". Herein, x is any single character.

The character string indicating the ejection amount level is a character string indicating, among a plurality of levels obtained by dividing a range that an amount of ink droplets ejected from a general ink jet head HU, that is, an ejection amount, can take, a level to which the ejection amount of the ink jet head HU used by the registered user Ur belongs. In the present specification, in order to simplify the description, the character string indicating the ejection amount level is indicated as "Iw_x". Herein, x is any single character. In the present specification, the range that the ejection amount can take is divided into four levels. Character strings indicating the four levels are "Iw_A" when the ejection amount is less than 4 [ng], "Iw_B" when the ejection amount is 4 [ng] or greater and less than 7 [ng], "Iw_C" when the ejection amount is 7 [ng] or greater and less than 10 [ng], and "Iw_D" when the ejection amount is 10 [ng] or greater. Herein, [ng] means a nanogram.

The character string indicating the ejection speed level is a character string indicating, among a plurality of levels obtained by dividing a range that a speed of ink droplets ejected from a general ink jet head HU, that is, an ejection speed, can take, a level to which the ejection speed of the ink jet head HU used by the registered user Ur belongs. In the present specification, in order to simplify the description, the character string indicating the ejection speed level is indicated as "Vm_x". In the present specification, the range that the ejection speed can take is divided into four levels. Character strings indicating the four levels are "Vm_A" when the ejection speed is less than 6 [m/s], "Vm_B" when the ejection speed is 6 [m/s] or greater and less than 9 [m/s], "Vm_C" when the ejection speed is 9 [m/s] or greater and less than 12 [m/s], and "Vm_D" when the ejection speed is 12 [m/s] or greater.

The ejection amount level and the ejection speed level correspond to "a plurality of items relating to the ejection of ink", and also correspond to "a plurality of ejection characteristic items included in ejection characteristics of the ink jet head".

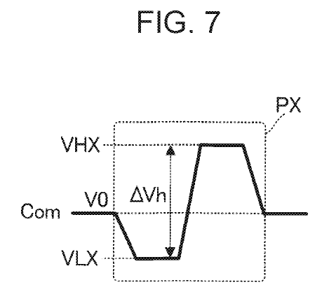

The character string for identifying the waveform information is a character string for identifying waveform information indicating the drive waveform applied to the ink jet head HU used by the registered user Ur. The waveform information indicates values of a potential applied to the ink jet head HU during one drive period obtained by dividing an operation period of the ink jet printer 10. In the present specification, in order to simplify the description, the character string for identifying the waveform information is indicated as "No_x". Herein, x is any single character. Unlike the example of FIG. 6, the character string for identifying the waveform information may be, for example, a character string indicating a feature of the drive waveform indicated by the waveform information. The character string indicating the feature of the drive waveform indicated by the waveform information is, for example, a character string such as "large dot waveform" or "small dot waveform". The waveform information will be described with reference to FIG. 7.

FIG. 7 is a diagram showing an example of the drive waveform PX indicated by the waveform information. The drive waveform PX has a first period for decreasing the potential from the intermediate potential V0 to a lowest potential VLX, a second period for maintaining the lowest potential VLX, a third period for increasing the potential from the lowest potential VLX to a highest potential VHX, a fourth period for maintaining the highest potential VHX, and a fifth period for decreasing the potential from the highest potential VHX to the intermediate potential V0. The waveform information has, for example, termination information including information indicating a termination time of each period of the drive waveform PX and information indicating a termination potential. For example, the waveform information has termination information for each of the first period to the fifth period.

The character string for identifying the waveform information is an example of "information regarding waveform information". The information regarding the waveform information is not limited to the character string for identifying the waveform information. For example, the information regarding the waveform information may be image information indicating a shape of the drive waveform indicated by the waveform information.

The description returns to FIG. 6. The character string indicating the temperature range indicates the range of ambient temperature when the registered user Ur uses the ink jet head HU. In the present specification, the character string indicating the temperature range is "T ≤ 10", which indicates that the ambient temperature is 10 degrees Celsius or less; "10 < T ≤ 20", which indicates that the ambient temperature is greater than 10 degrees Celsius and 20 degrees Celsius or less; "20 < T ≤ 30", which indicates that the ambient temperature is greater than 20 degrees Celsius and 30 degrees Celsius or less; "30 < T ≤ 40", which indicates that the ambient temperature is greater than 30 degrees Celsius and 40 degrees Celsius or less; and "40 < T", which indicates that the ambient temperature is greater than 40 degrees Celsius. The temperature range is an example of "a usage environment of the ink jet head".

FIG. 8 is a diagram showing contents of the ink table IkT. The ink table IkT has one or more records RC2 in which information regarding ink is associated for one or more inks. The ink table IkT has one or more records RC2 having a character string indicating a type of ink, a numerical value indicating a density, a numerical value indicating a viscosity, a numerical value indicating a surface tension, a character string indicating a type of solvent, a character string indicating a type of colorant, and information indicating application suitability. The ink table IkT shown in FIG. 8 includes records RC2_1 to RC2_4. Hereinafter, the records included in the ink table IkT may be referred to, without distinction, as the record RC2. Additionally, the record RC1 and the record RC2 may be referred to, without distinction, as the record RC.

The record RC2 is registered in the ink table IkT by the head manufacturer, but may also be registered by the user U of the evaluation apparatus 20.

The character string indicating the type of ink is the same as the character string indicating the type of ink in the correspondence information CI. However, the character string indicating the type of ink in the ink table IkT is also a character string for uniquely specifying the record RC2. Hereinafter, ink that is uniquely identified by the character string indicating the type of ink of one record RC2 may be referred to as a registered ink.

The numerical value indicating the density is a numerical value indicating the density of the registered ink. Hereinafter, the numerical value indicating the density may be referred to as a density value. In the example of FIG. 8, the density value of the registered ink is indicated in units of [kg/m³].

The numerical value indicating the viscosity is a numerical value indicating the viscosity of the registered ink. Hereinafter, the numerical value indicating the viscosity may be referred to as a viscosity value. In the example of FIG. 8, the viscosity value of the registered ink is indicated in units of [mPa·s].

The numerical value indicating the surface tension is a numerical value indicating the surface tension of the registered ink. Hereinafter, the numerical value indicating the surface tension may be referred to as a surface tension value. In the example of FIG. 8, the surface tension value of the registered ink is indicated in units of [mN/m].

The character string indicating the type of solvent is a character string indicating the type of solvent of the registered ink.

The character string indicating the type of colorant is a character string indicating the type of colorant of the registered ink.

The information indicating the application suitability is application suitability information indicating, for each of one or more applications in which the ink jet head HU is used, whether or not the registered ink is suitable for the application. The application suitability information includes a character string "OK" indicating that the registered ink is suitable for the application, and the character string "NG" indicating that the registered ink is not suitable for the application. In the example of FIG. 8, the application suitability information indicates, as three applications, whether or not the registered ink is suitable for signboard printing, whether or not the registered ink is suitable for label printing, and whether or not the registered ink is suitable for printing on fabric.

In addition to the type of ink, each of the items, namely the density, the viscosity, the surface tension, the type of solvent, the type of colorant, and the application suitability, corresponds to "one or more items relating to ejection of ink", and also corresponds to "one or more items relating to the ink". The application suitability item also corresponds to "an item relating to an application in which the ink jet head is used". In addition, the density, the viscosity, and the surface tension correspond to "one or more physical properties of the ink". The density value, the viscosity value, and the surface tension value correspond to "one or more physical property values of the ink". Further, signboard printing, label printing, and printing on fabric are examples of "an application in which the ink jet head is used".

The record RC2 shown in FIG. 8 has all of the item values shown in FIG. 8, but may have only a part of the item values.

The records RC1 included in the correspondence information CI and the records RC2 included in the ink table IkT are an example of "a plurality of sets". The records RC1 included in the correspondence information CI and the records RC2 included in the ink table IkT are used by one or more users who can access the system SYS.

The history database RD may include, in addition to the items shown in FIGS. 6 and 8, one or more items relating to the ink jet head HU. The one or more items relating to the ink jet head HU are, for example, one or a plurality of items among a model number of the ink jet head HU, a type of ink corresponding to the ink jet head HU, a size of the ink jet head HU, an image indicating an appearance of the ink jet head HU, the number of nozzles Nz of the ink jet head HU, a resolution of the ink jet head HU, an effective print width of the ink jet head HU, the number of ink colors of the ink jet head HU, whether or not ink circulates in the ink jet head HU, a viscosity of ink corresponding to the ink jet head HU, and an amount of ink droplets of the ink jet head HU.

In addition, the history database RD may include, in addition to one or more items relating to the ink jet head HU, an item relating to an ink cartridge and a minimum value of a drive period. The minimum value of the drive period can also be referred to as a maximum value of a drive frequency. Further, the history database RD may include, as an example of the ejection characteristic item, an image of ink droplets ejected from the ink jet head HU, one or more items relating to ejection stability, and residual vibration. Residual vibration is vibration remaining in a pressure chamber to which pressure is applied by a piezoelectric element, which is an example of a drive element (not shown) provided in the ink jet head HU, after the drive signal Com is supplied to the piezoelectric element. An item value corresponding to the residual vibration is information indicating a potential corresponding to an electromotive force of the piezoelectric element caused by the residual vibration until a certain period elapses after the drive signal Com is supplied. The ink jet head HU does not necessarily include the piezoelectric element and may include a heating element. The one or more items relating to the ejection stability are, for example, variation in ejection speed, ejection speed vector deflection, and the number of satellites. An item value corresponding to the variation of ejection speed is, for example, a variance value of the ejection speed. The ejection speed vector deflection is a value indicating an angle of an ejection direction with respect to a Z-axis. A satellite is a minute ink droplet separated from an ink droplet when the ink droplet is ejected. Accordingly, an item value corresponding to the number of satellites is a numerical value indicating the number of minute ink droplets separated from the ink droplet.

Further, the history database RD may include, as an example of a "usage environment of the ink jet head", a humidity range. The humidity range is a range of ambient humidity when the ink jet head HU is used by the registered user Ur.

Furthermore, the history database RD may include an item relating to the ink excluding each item corresponding to "one or more items relating to the ink" included in the ink table IkT shown in FIG. 8. The item relating to the ink is, for example, components of the ink, a speed at which sound propagates in the ink, a contact angle on the medium PP or in the nozzle Nz, a concentration of solid components contained in the ink, and a particle size distribution in the ink.

In addition, the history database RD may include comments by the user U. Further, as described above, it is described that the history database RD may have a function of enabling high ratings to be set for the record RC1, but the user U may set ratings for the record RC1 and may also set a comment. A rating for a certain record RC1 may be made by the user U who registers the certain record RC1 or may be made by a user U different from the user U who registers the record RC1. For example, a user U_y different from the user U who registers a certain record RC1_x downloads, to an evaluation apparatus 20_y, waveform information identified by the record RC1_x. The evaluation apparatus 20_y supplies, to the ink jet head HU, the drive signal Com having the drive waveform indicated by the downloaded waveform information. The evaluation apparatus 20_y transmits, to the cloud server CS, a comment indicating a rating by the user U_y for an ejection result. The cloud server CS associates the received comment with the record RC1_x. Similarly, in the history database RD, a high rating may be set for the record RC2, and a comment may be set for the record RC2.

The history database RD is an example of "history information". The correspondence information CI shown in FIG. 6 has item values corresponding to six items relating to the ejection of ink, namely the type of ink, the type of head, the ejection amount level, the ejection speed level, the drive waveform indicated by the waveform information, and the temperature range, but need only have two or more items relating to the ejection of ink. For example, when the correspondence information CI has item values corresponding to two items relating to the ejection of ink, one of the two items corresponds to a "first item", and the other item corresponds to a "second item". Additionally, the correspondence information CI need only have one or more item values corresponding to the item relating to the ejection of ink.

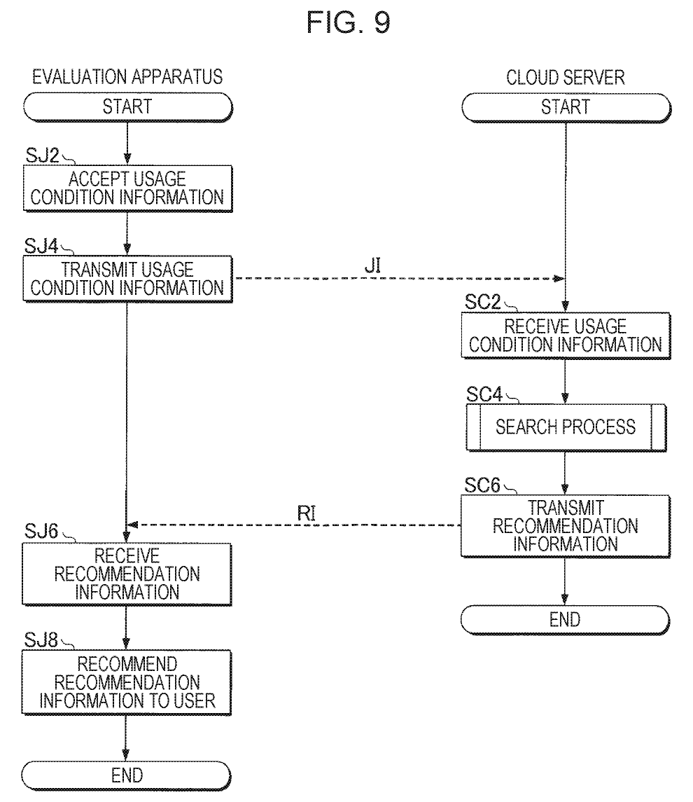

FIG. 9 is a flowchart showing operations of the system SYS. In step SJ2, the control circuit 21 of the evaluation apparatus 20_x operated by the user U_x functions as the acceptance section 211, and accepts the usage condition information JI including one or more input item values based on the operation information of the user U_x via the input device 26. Herein, x is any integer from 1 to 3. Step SJ2 corresponds to an "acceptance step".

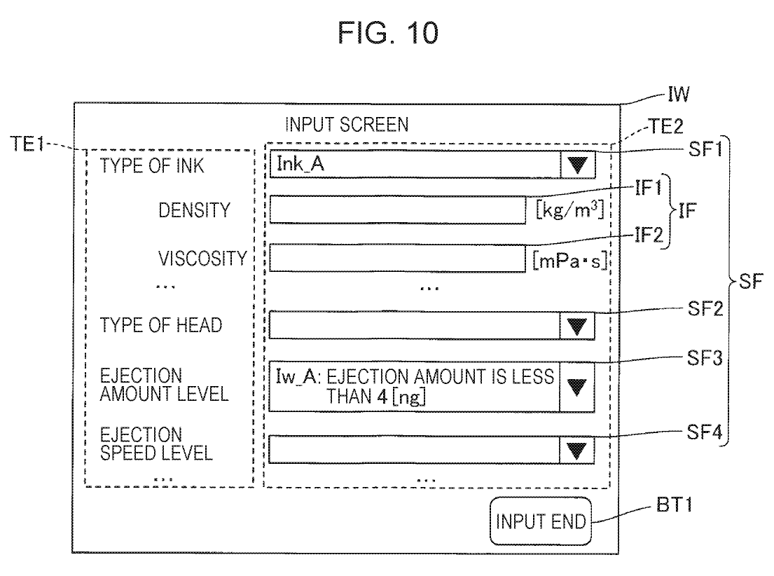

The user U_x is an example of a "specific user". However, the history database RD indicates a history in which the ink jet head HU is used by a user different from the user U_x. The "user different from the user U_x" may be a user U of the evaluation apparatus 20 different from the user U_x, or may be the head manufacturer. In addition, the user U_x may or may not previously register the record RC included in the history database RD. That is, the history database RD may or may not include a history in which the ink jet head HU is used by the user U_x. In other words, "history information indicating a history of use by a user different from the specific user" may or may not include a history of use by the "specific user". In processing in step SJ2, specifically, the evaluation apparatus 20_xdisplays, on the display device 27, an input screen IW for the user U_x to input the usage condition information JI, and waits for operation by the user U_x. An example of the input screen IW will be described with reference to FIG. 10.

FIG. 10 is a diagram showing an example of the input screen IW. The input screen IW is a screen for the user U_x to input input item values corresponding to one or more items relating to the ejection of ink. The input screen IW includes a region TE1 in which names of two or more items relating to the ejection of ink are displayed, a region TE2 in which an input field IF and a selection field SF for inputting input item values corresponding to the two or more items relating to the ejection of ink are disposed, and an input end button BT1. In FIG. 10, in order to prevent the drawing from being complicated, among the items relating to the ejection of ink shown in FIGS. 6 and 8, only six items are displayed, namely the type of ink, the density, the viscosity, the type of head, the ejection amount level, and the ejection speed level. In the region TE2 shown in FIG. 10, two input fields IF and four selection fields SF are disposed. The two input fields IF are an input field IF1 for the user U_x to input the density value and an input field IF2 for the user U_x to input the viscosity value. The four selection fields SF are a selection field SF1 for the user U_x to select the character string indicating the type of ink, a selection field SF2 for the user U_x to select the character string indicating the type of head, a selection field SF3 for the user U_x to select the character string indicating the ejection amount level, and a selection field SF4 for the user U_x to select the character string indicating the ejection speed level.

The user U_x operates the input device 26 and, among the input fields IF and the selection fields SF disposed in the region TE2, inputs or selects an item value for at least one field. For example, when the user U_x desires to use ink registered in the history database RD, the user U_x selects, from the selection field SF1, a character string indicating the type of ink. On the other hand, when ink is not registered in the history database RD, the user U_x inputs a physical property value of ink that the user U_x desires to use, such as the density value, the viscosity value, and the surface tension value (not shown in FIG. 10). The input screen IW shown in FIG. 10 shows a state in which "Ink_A" is selected in the selection field SF1 by the user U_x and "Iw_A" is selected in the selection field SF3. When the input end button BT1 is pressed, the evaluation apparatus 20_x generates the usage condition information JI having the input item values input or selected at a time point at which the input end button BT1 is pressed.

The description returns to FIG. 9. After the end of the processing in step SJ2, in step SJ4, the control circuit 21 functions as the transmission section 213, controls the communication device 23, and transmits the usage condition information JI to the cloud server CS. After the end of the processing in step SJ4, the control circuit 21 waits for a response from the cloud server CS.

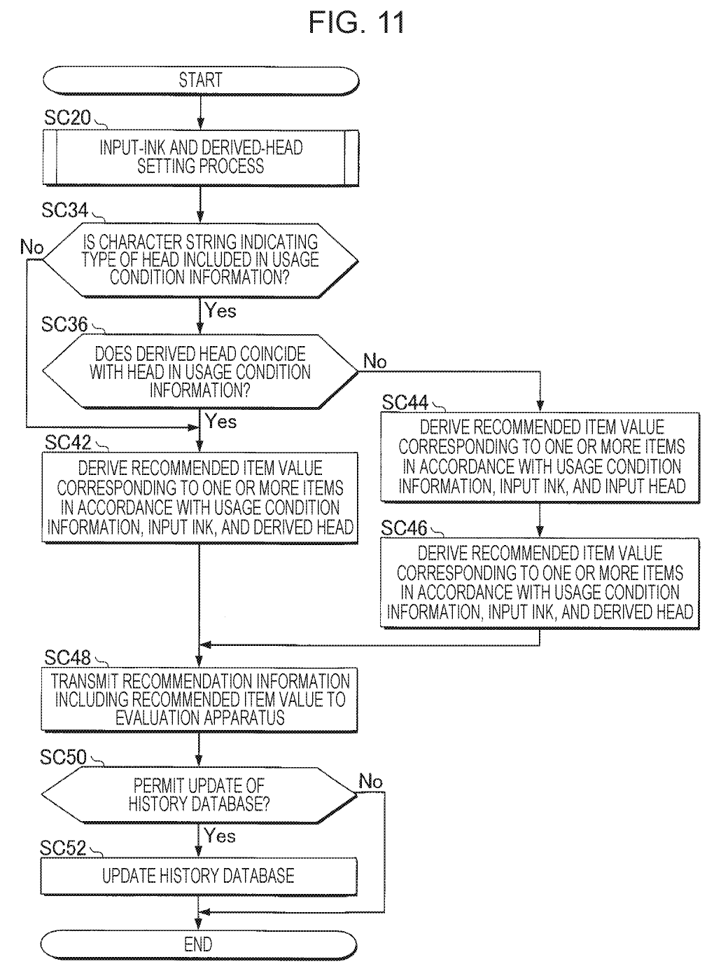

In step SC2, the cloud server CS functions as the reception section 301, and the cloud server CS receives the usage condition information JI from the evaluation apparatus 20_x. By executing the processing in step SC2, the cloud server CS also functions as an "acquisition section" that acquires the usage condition information JI. After the end of the processing in step SC2, in step SC4, the cloud server CS functions as the search section 303 and executes a search process. The search process will be described with reference to FIG. 11.

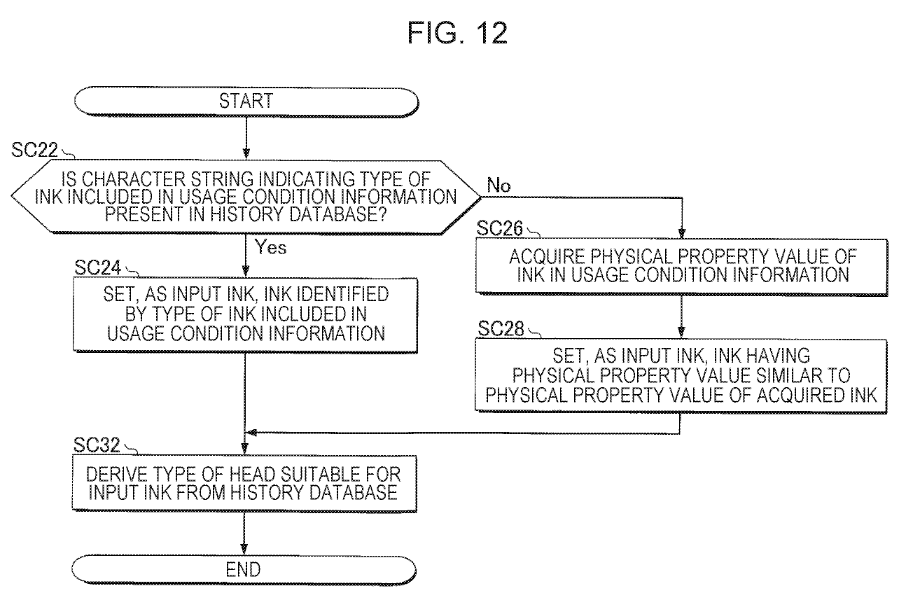

FIG. 11 is a flowchart showing an operation of the search process. In step SC20, the cloud server CS executes an input-ink and derived-head setting process. The input-ink and derived-head setting process will be described with reference to FIG. 12.

FIG. 12 is a flowchart showing the input-ink and derived-head setting process. The input-ink and derived-head setting process is a process of setting an input ink, which will be described below, and a derived head, which will be described below. In step SC22, the cloud server CS determines whether or not the character string indicating the type of ink included in the usage condition information JI is present in the history database RD. When the usage condition information JI does not include the character string indicating the type of ink, the cloud server CS determines that a determination result of step SC22 is negative.

When the determination result of step SC22 is affirmative, in step SC24, the cloud server CS sets, as the input ink, ink identified by the type of ink included in the usage condition information JI. On the other hand, when the determination result of step SC22 is negative, in step SC26, the cloud server CS acquires the physical property value of the ink in the usage condition information JI. The physical property value of the ink is one or a plurality of values among the density value, the viscosity value, and the surface tension value, as described above. When the usage condition information JI does not include the physical property value of the ink, the cloud server CS may request the evaluation apparatus 20_x to prompt the user U_x to input the physical property value of the ink.

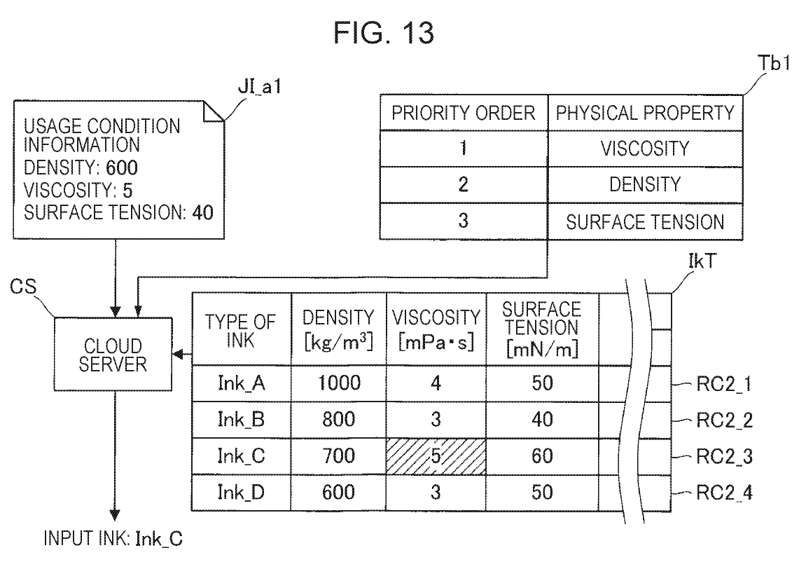

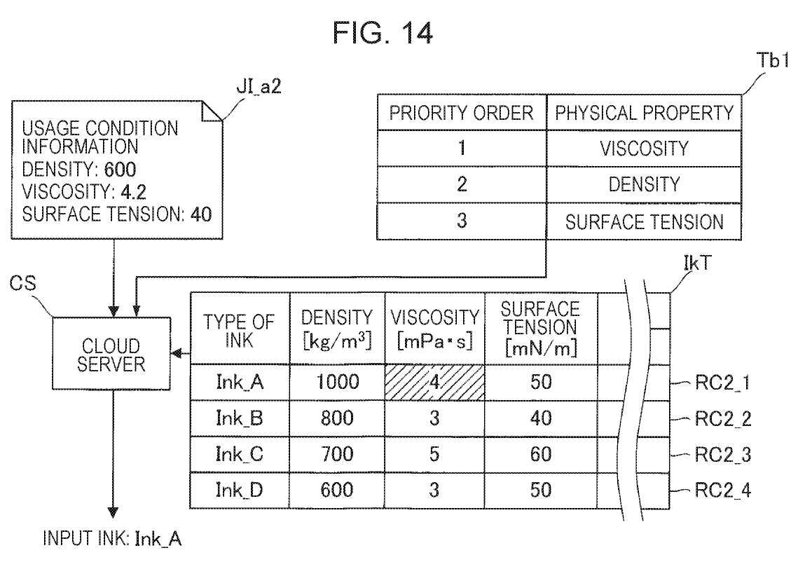

After the end of the processing in step SC26, in processing in step SC28, the cloud server CS sets, as the input ink, ink similar to the ink acquired by the processing in step SC26 among one or more inks registered in the ink table IkT. In the first embodiment, the cloud server CS sets, as the input ink, ink having a physical property value similar to the physical property value of the ink acquired by the processing in step SC26. Hereinafter, ink registered in the ink table IkT may be referred to as "registered ink". Additionally, the physical property value of the ink acquired by the processing in step SC26 may be referred to as an "acquired physical property value". Further, hereinafter, in the acquired physical property value, the viscosity value may be referred to as an "acquired viscosity value", in the acquired physical property value, the density value may be referred to as an "acquired density value", and in the acquired physical property value, the surface tension value may be referred to as an "acquired surface tension value". The processing in step SC28 will be described with reference to FIGS. 13 and 14.

FIGS. 13 and 14 are diagrams illustrating the processing in step SC28. In FIGS. 13 and 14, as two examples of the usage condition information JI, usage condition information JI_a1 and usage condition information JI_a2 are shown. Hereinafter, the usage condition information JI_a1 and the usage condition information JI_a2 may be referred to, without distinction, as the usage condition information JI. For ease of understanding, the usage condition information JI shown in FIGS. 13 and 14 includes names of items such as "density", but the usage condition information JI may or may not include names of items.

In the processing in step SC28, the cloud server CS determines ink having a physical property value similar to the acquired physical property value in accordance with Table Tb1 shown in FIG. 13. Table Tb1 shows that, for determining whether or not the physical property values of two inks are similar, among three physical properties of ink, namely the density, the viscosity, and the surface tension, the viscosity is used with the highest priority, the density is used with the next priority, and the surface tension is used last. Specifically, in step SC28, as a viscosity comparison process, the cloud server CS determines whether or not, among viscosity values of respective registered inks of the one or more registered inks, there is a value close to the acquired viscosity value. The expression that the viscosity value of each of the registered inks of the one or more registered inks is close to the acquired viscosity value means that an absolute value of a value obtained by subtracting the acquired viscosity value from the viscosity value of any registered ink among the one or more registered inks is less than a threshold value determined in advance by the head manufacturer. When the viscosity value of any one registered ink among the one or more registered inks is close to the acquired viscosity value, the cloud server CS sets, as the input ink, the registered ink having the viscosity value close to the acquired viscosity value. When the viscosity values of two or more registered inks are close to the acquired viscosity value, the cloud server CS sets, as the input ink, the registered ink having the viscosity value closest to the acquired viscosity value. On the other hand, when the viscosity values of all registered inks among the one or more registered inks are not close to the acquired viscosity value, the cloud server CS executes a density comparison process, which will be described below. When the acquired physical property value does not include the viscosity value, the cloud server CS also executes the density comparison process.

When the viscosity values of all registered inks among the one or more registered inks are not close to the acquired viscosity value, or when the acquired physical property value does not include the viscosity value, the cloud server CS determines whether or not, among the density values of the respective registered inks of the one or more registered inks, there is a value close to the acquired density value, as the density comparison process. Hereinafter, the cloud server CS executes the density comparison process in the same manner as the viscosity comparison process. When the density values of all registered inks among the one or more registered inks are not close to the acquired density value, the cloud server CS executes a surface tension comparison process, which will be described below. When the acquired physical property value does not include the density value, the cloud server CS also executes the surface tension comparison process.

When the density values of all registered inks among the one or more registered inks are not close to the acquired density value, or when the acquired physical property value does not include the density value, the cloud server CS determines whether or not, among the surface tension values of the respective registered inks of the one or more registered inks, there is a value close to the acquired surface tension value, as the surface tension comparison process. When the surface tension values of all registered inks among the one or more registered inks are not close to the surface tension value in the acquired physical property value, or when the acquired physical property value does not include the surface tension value, the cloud server CS may regard that there is no ink having a physical property value similar to the physical property value of the ink acquired by the processing in step SC28 and may end a series of processes shown in FIGS. 9, 11, and 12. Alternatively, the cloud server CS may cause the user U_x to select, from the one or more registered inks, ink that the user U_x considers to be similar to the ink for which the physical property value is acquired by the processing in step SC26.

The usage condition information JI_a1 illustrated in FIG. 13 has, as the input item values, a density value of the ink of 600 [kg/m³], a viscosity value of the ink of 5 [mPa·s], and a surface tension value of the ink of 40 [mN/m]. In step SC28, since the viscosity value of the registered ink "Ink_C" registered in record RC2_3 is 5 [mPa·s], the cloud server CS sets the registered ink "Ink_C" as the input ink.

The usage condition information JI_a2 illustrated in FIG. 14 is different from the usage condition information JI_a1 in that 4.2 [mPa·s], which is the viscosity value of the ink, is included as the input item value, and the other physical property values are the same. In the example of FIG. 14, an absolute value of a value obtained by subtracting the acquired viscosity value 4.2 [mPa·s] from the viscosity value 4 [mPa·s] of registered ink "Ink_A" registered in the record RC2_1 is 0.2 [mPa·s]. In addition, an absolute value of a value obtained by subtracting the acquired viscosity value 4.2 [mPa·s] from the viscosity value 5 [mPa·s] of registered ink "Ink_C" registered in the record RC2_3 is 0.8 [mPa·s]. It is assumed that 0.2 [mPa·s] and 0.8 [mPa·s] are less than a threshold value determined in advance by the head manufacturer. In this case, the cloud server CS sets, as the input ink, the registered ink "Ink_A" having a viscosity value closest to the acquired viscosity value.

In the example of FIG. 14, the viscosity of the ink corresponds to a "first item", the density or the surface tension of the ink corresponds to a "second item", and the type of ink corresponds to a "third item". The acquired viscosity value 4.2 [mPa·s] corresponds to a "third viscosity value", the viscosity value 4 [mPa·s] of the registered ink "Ink_A" corresponds to a "first viscosity value", and the viscosity value 5 [mPa·s] of the registered ink "Ink_C" corresponds to a "second viscosity value". Therefore, the absolute value 0.2 [mPa·s] of the difference between 4 [mPa·s] corresponding to the "first viscosity value" and 4.2 [mPa·s] corresponding to the "third viscosity value" is smaller than the absolute value 0.8 [mPa·s] of the difference between 5 [mPa·s] corresponding to the "second viscosity value" and 4.2 [mPa·s] corresponding to the "third viscosity value". The character string "Ink_A" indicating the type of ink corresponds to "first ink information indicating a type of first ink", and the character string "Ink_C" indicating the type of ink corresponds to "second ink information indicating a type of second ink". In the history database RD, a record RC including the acquired viscosity value 4.2 [mPa·s] is not present. The record RC2_1 corresponds to "a set including the first viscosity value and the first ink information", and the record RC2_3 corresponds to "a set including the second viscosity value and the second ink information". The information indicating the type of ink is not limited to the character string indicating the type of ink, and may be, for example, a numerical value indicating the type of ink, or an ID. ID is an abbreviation for "identification".

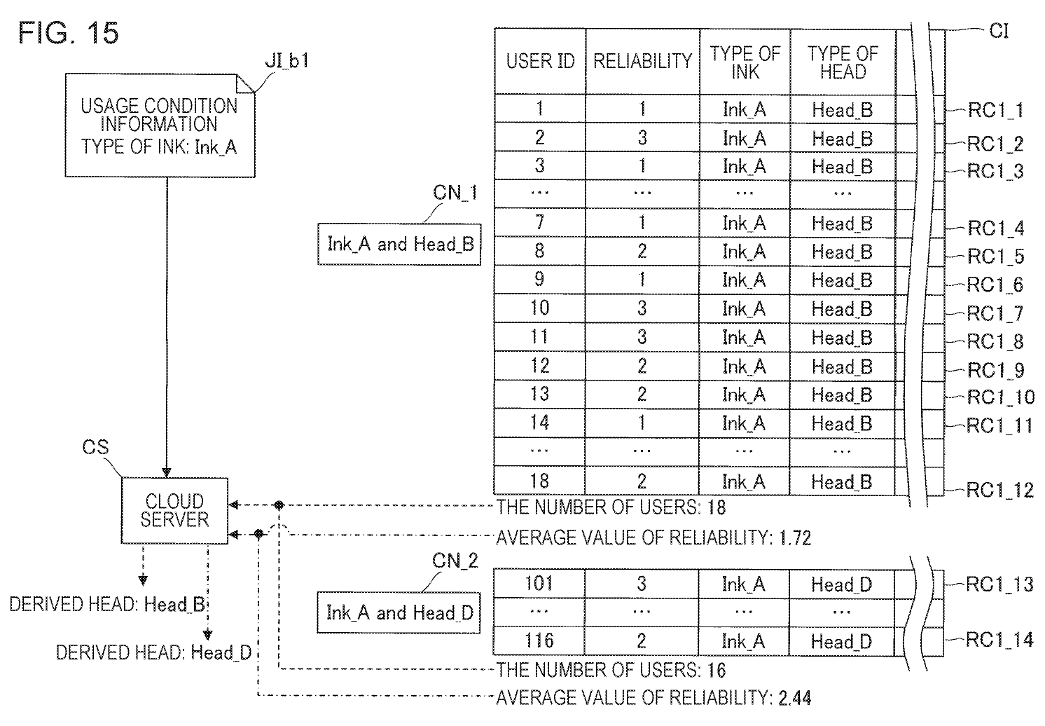

The description returns to FIG. 12. After the end of the processing in step SC24, or after the end of the processing in step SC28, in step SC32, the cloud server CS derives, from the history database RD, the type of head suitable for the input ink. Hereinafter, the ink jet head HU derived in step SC32 may be referred to as a "derived head". After the end of step SC32, the cloud server CS ends the series of processes shown in FIG. 12. The processing in step SC32, that is, the process of setting the derived head will be described with reference to FIG. 15.

FIG. 15 is a diagram illustrating the process of setting the derived head. In FIG. 15, as one example of the usage condition information JI, usage condition information JI_b1 is shown.

The process of setting the derived head has, for example, two aspects shown below. In the example of FIG. 15, an arrow relating to processing of a first aspect for setting the derived head is indicated by a dashed arrow, and an arrow relating to processing of a second aspect for setting the derived head is indicated by an alternating long- and short-dashed arrow.

In the first aspect for setting the derived head, the cloud server CS refers to the records RC1 including the character string indicating the type of the input ink, and sets, as the derived head, the ink jet head HU with the largest number of users. The history database RD can specify the number of users using the records RC1 including the character string indicating the type of the input ink and the character string indicating the type of head. The "number of users using the records RC1" may mean a cumulative number of users, that is, when the same person registers two or more records RC1, the person may be counted as different persons; alternatively, when the same person registers two or more records RC1, the person may be counted as one. The fact that the number of users using the records RC1 can be specified means that a numerical value indicating the number of users using the records RC1 may be included in the history database RD, or the number of users using the records RC1 may be specified by counting the number of records RC1.

The usage condition information JI_b1 illustrated in FIG. 15 has "Ink_A", which is the character string indicating the type of ink. In addition, in the example of FIG. 15, the premise is that there are 18 records RC1 satisfying an extraction condition CN_1 in which the character string indicating the type of ink is "Ink_A" and the character string indicating the type of head is "Head_B". Further, the premise is that there are 16 records RC1 satisfying an extraction condition CN_2 in which the character string indicating the type of ink is "Ink_A" and the character string indicating the type of head is "Head_D". Accordingly, since the number of records RC1 satisfying the extraction condition CN_1 is greater than the number of records RC1 satisfying the extraction condition CN_2, the cloud server CS sets the derived head to "Head_B".

In the second aspect for setting the derived head, the cloud server CS refers to the records RC1 including the character string indicating the type of the input ink, and sets, as the derived head, the ink jet head HU with the highest representative value of reliability of one or more users. The representative value of reliability of the one or more users is a value indicating a central tendency of reliability of the one or more users, and is typically an average value. However, the representative value is not limited to the average value, and may be, for example, a median value or a mode value. Hereinafter, description is given assuming that the representative value is an average value. The history database RD can specify an average value of reliability of one or more users using the records RC1 including the character string indicating the type of the input ink and the character string indicating the type of head. The fact that the average value of reliability of the one or more users using the records RC1 can be specified means that the average value of reliability of the one or more users using the records RC1 may be included in the history database RD, or the average value of reliability of the one or more users using the records RC1 may be specified by calculating the average value of reliability of the one or more users using the records RC1.

In the example of FIG. 15, the premise is that the average value of reliability of the records RC1 satisfying the extraction condition CN_1 is 1.72, and the average value of reliability of the records RC1 satisfying the extraction condition CN_2 is 2.44. Accordingly, since the average value of reliability of the records RC1 satisfying the extraction condition CN_2 is greater than the average value of reliability of the records RC1 satisfying the extraction condition CN_1, the cloud server CS sets the derived head to "Head_D".

The cloud server CS may execute an aspect in which the first aspect and the second aspect for setting the derived head are combined. For example, the cloud server CS may refer to the records RC1 including the character string indicating the type of the input ink, and set, as the derived head, the ink jet head HU with the largest reliability-weighted number of users.

In addition, in common to the first aspect and the second aspect for setting the derived head, the type of ink is an example of a "first item", "Ink_A" is an example of a "first item value", the type of head is an example of a "second item", "Head_B" is an example of a "second item value", and "Head_D" is an example of a "third item value". Further, the extraction condition CN_1 is an example of "a first condition including the first item value and the second item value", and the extraction condition CN_2 is an example of "a second condition including the first item value and the third item value". The record RC1 satisfying the extraction condition CN_1 is an example of "a set satisfying the first condition", and the record RC1 satisfying extraction condition CN_2 is an example of "a set satisfying the second condition".

The description returns to FIG. 11. After the end of the processing in step SC32, in step SC34, the cloud server CS determines whether or not the usage condition information JI includes the character string indicating the type of head.

When the determination result of step SC34 is affirmative, in step SC36, the cloud server CS determines whether or not the derived head coincides with the ink jet head HU identified by the character string indicating the type of head in the usage condition information JI. Hereinafter, the ink jet head HU identified by the type of head included in the usage condition information JI may be referred to as an "input head".

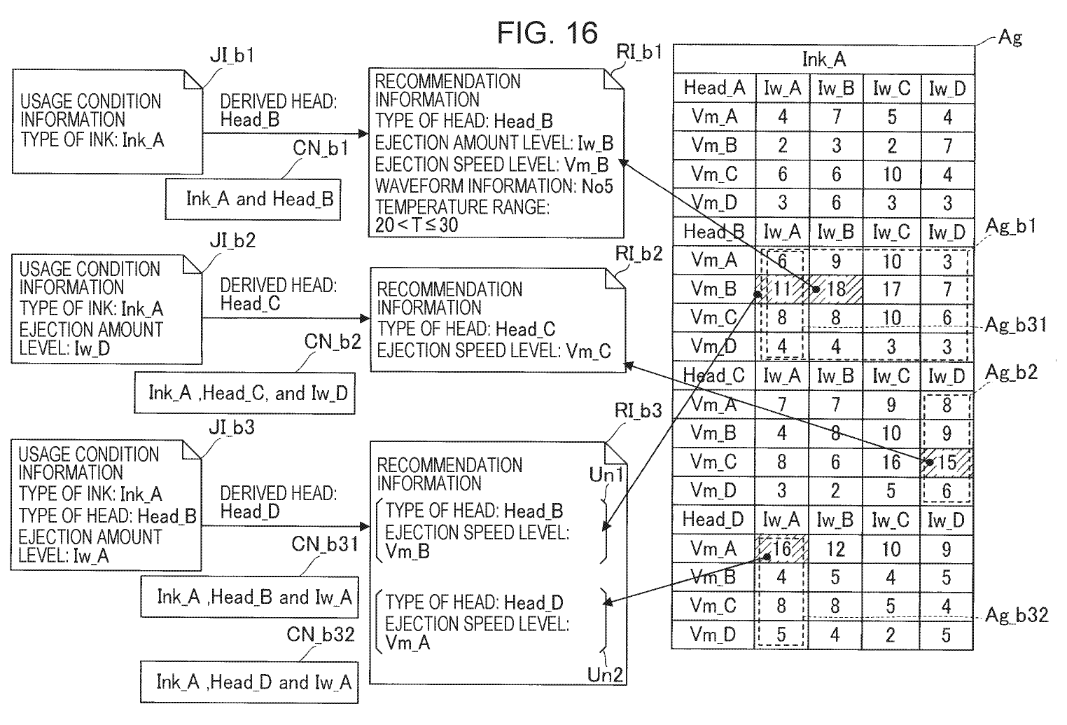

When the determination result of step SC36 is affirmative, in step SC42, the cloud server CS derives an item value corresponding to one or more items among the ejection characteristic, the drive waveform, and the temperature range corresponding to the usage condition information JI, the input ink, and the derived head. The derived item value is an item value to be recommended to the user U_x. Hereinafter, the derived item value may be referred to as a "recommended item value". The "recommended item value corresponding to the usage condition information JI, the input ink, and the derived head" is an item value, among the records RC1 having the item value included in the usage condition information JI, the input ink, and the derived head, excluding the item value included in the usage condition information JI, the input ink, and the derived head. Specific processing of step SC42 will be described below with FIG. 16. When the determination result of step SC34 is negative, the cloud server CS also executes the processing in step SC42.

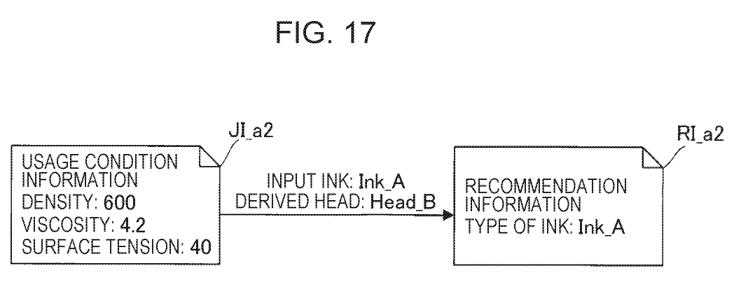

When the determination result of step SC36 is negative, in step SC44, the cloud server CS derives a recommended item value corresponding to one or more items among the ejection characteristics, the drive waveform, and the temperature range corresponding to the usage condition information JI, the input ink, and the input head. Additionally, in step SC46, the cloud server CS derives a recommended item value corresponding to one or more items among the ejection characteristic, the drive waveform, and the temperature range corresponding to the usage condition information JI, the input ink, and the derived head. In steps SC42, SC44, and SC46, the cloud server CS generates recommendation information RI having the derived recommended item value. Steps SC42, SC44, and SC46, that is, generation examples of the recommendation information RI, will be described with FIGS. 16 and 17.

FIGS. 16 and 17 are diagrams illustrating the generation examples of the recommendation information RI. An aggregation table Ag shown in FIG. 16 aggregates, among all the records RC1 of the correspondence information CI, the records RC1 satisfying the condition that the character string indicating the type of ink is "Ink_A", and indicates, for each combination of the type of head, the ejection amount level, and the ejection speed level, the number of users. For example, the aggregation table Ag indicates that, for the records RC1 satisfying the condition that the character string indicating the type of ink is "Ink_A", the character string indicating the type of head is "Head_A", the character string indicating the ejection amount level is "Iw_A", and the character string indicating the ejection speed level is "Vm_A", the number of users is four.

In FIG. 16, three examples of the usage condition information JI, namely usage condition information JI_b1, usage condition information JI_b2, and usage condition information JI_b3, are shown. In FIG. 17, an example of the usage condition information JI, namely usage condition information JI_a2, is shown. Additionally, in FIG. 16, recommendation information RI_b1 generated based on the usage condition information JI_b1, recommendation information RI_b2 generated based on the usage condition information JI_b2, and recommendation information RI_b3 generated based on the usage condition information JI_b3 are shown. In FIG. 17, recommendation information RI_a2 generated based on the usage condition information JI_a2 is shown. Hereinafter, the recommendation information RI_b1, the recommendation information RI_b2, the recommendation information RI_b3, and the recommendation information RI_a2 may be referred to, without distinction, as the recommendation information RI. For ease of understanding, the recommendation information RI shown in FIGS. 16 and 17 includes names of items such as the "type of head"; however, the recommendation information RI may or may not include names of items.

In the usage condition information JI_b1, the premise is that the derived head is set to "Head_B". In addition, the usage condition information JI_b1 does not include the character string indicating the type of head. Therefore, the cloud server CS determines that the determination result of step SC34 is negative, and executes the processing in step SC42. The usage condition information JI_b1 includes only the character string indicating the type of ink "Ink_A". Accordingly, the cloud server CS searches, from the records RC1 satisfying an extraction condition CN_b1 that the character string indicating the type of ink is "Ink_A" and the character string indicating the type of head is "Head_B", for a set of the ejection amount level and the ejection speed level with the largest number of users. Among the records RC1 satisfying the extraction condition CN_b1, the numbers of users for each combination of the ejection amount level and the ejection speed level are indicated by a range Ag_b1 shown in FIG. 16. As understood from the range Ag_b1, among the combinations of the ejection amount level and the ejection speed level obtained from the records RC1 satisfying the extraction condition CN_b1, the set in which the character string indicating the ejection amount level is "Iw_B" and the character string indicating the ejection speed level is "Vm_B" has the largest number of users. Therefore, the cloud server CS generates one or more item values not included in the usage condition information JI, from the item values of the record RC1 having "Ink_A", "Head_B", "Iw_B", and "Vm_B", as the recommendation information RI_b1. In the example of FIG. 6, the records RC1 having "Ink_A", "Head_B", "Iw_B", and "Vm_B" are the records RC1_1 to RC1_12. The cloud server CS generates the recommendation information RI_b1 including "Head_B", "Iw_B", and "Vm_B" as recommendation item values. The recommendation information RI_b1 means that, when the type of ink is "Ink_A", usage conditions in which the type of head is "Head_B", the ejection amount level is "Iw_B", and the ejection speed level is "Vm_B" are recommended to the user U_x. Furthermore, the cloud server CS may specify that, among the records RC1 satisfying the condition that the character string indicating the ejection amount level is "Iw_B" and the character string indicating the ejection speed level is "Vm_B", the records RC1 in which the character string for identifying the waveform information is "No5" and the character string indicating the temperature range is "20 < T ≤ 30" are the most numerous. The cloud server CS may include "No5" and "20 < T ≤ 30" as recommendation item values in the recommendation information RI_b1.

In the usage condition information JI_b2, the premise is that the derived head is set to "Head_C". In addition, the usage condition information JI_b2 does not include the character string indicating the type of head. Therefore, the cloud server CS determines that the determination result of step SC34 is negative, and executes the processing in step SC42. The usage condition information JI_b2 includes, in addition to the character string indicating the type of ink, the character string indicating the ejection amount level "Iw_D". Therefore, the cloud server CS searches, from the records RC1 satisfying an extraction condition CN_b2 that the character string indicating the type of ink is "Ink_A", the character string indicating the type of head is "Head_C", and the character string indicating the ejection amount level is "Iw_D", for the ejection speed level with the largest number of users. Among the records RC1 satisfying the extraction condition CN_b2, the numbers of users for each ejection speed level are indicated by a range Ag_b2 shown in FIG. 16. As understood from the range Ag_b2, among the ejection speed levels included in the records RC1 satisfying the extraction condition CN_b2, the character string indicating the ejection speed level "Vm_C" has the largest number of users. Accordingly, the cloud server CS generates the recommendation information RI_b2 including the character string indicating the type of head "Head_C" and the character string indicating the ejection speed level "Vm_C".

In the usage condition information JI_b3, the premise is that the derived head is set to "Head_D". In addition, the usage condition information JI_b3 includes the character string indicating the type of head, but the character string is different from the derived head. Therefore, the cloud server CS determines that the determination result of step SC36 is negative, and executes the processing in step SC44 and the processing in step SC46. The usage condition information JI_b3 includes, in addition to the character string indicating the type of ink and the character string indicating the type of head, the character string indicating the ejection amount level "Iw_A". Therefore, in step SC44, the cloud server CS searches, from the records RC1 satisfying an extraction condition CN_b31 that the character string indicating the type of ink is "Ink_A", the character string indicating the type of head is "Head_B", and the character string indicating the ejection amount level is "Iw_A", for the ejection speed level with the largest number of users. Among the records RC1 satisfying the extraction condition CN_b31, the numbers of users for each ejection speed level are indicated by a range Ag_b31 shown in FIG. 16. As understood from the range Ag_b31, among the ejection speed levels included in the records RC1 satisfying the extraction condition CN_b31, the character string indicating the ejection speed level "Vm_B" has the largest number of users. Therefore, the cloud server CS generates the recommendation information RI_b3 that has a set Un1 having "Head_B" and "Vm_B".

Additionally, in step SC46, the cloud server CS searches, from the records RC1 satisfying an extraction condition CN_b32 that the character string indicating the type of ink is "Ink_A", the character string indicating the type of head is "Head_D", and the character string indicating the ejection amount level is "Iw_A", for the ejection speed level with the largest number of users. Among the records RC1 satisfying the extraction condition CN_b32, the numbers of users for each ejection speed level are indicated by a range Ag_b32 shown in FIG. 16. As understood from the range Ag_b32, among the ejection speed levels included in the records RC1 satisfying the extraction condition CN_b32, the character string indicating the ejection speed level "Vm_A" has the largest number of users. Therefore, the cloud server CS adds a set Un2 having "Head_D" and "Vm_A" to the recommendation information RI_b3.

The record RC1 including "Ink_A", "Head_B", "Iw_A", and "Vm_B" and the record RC1 including "Ink_A", "Head_D", "Iw_A", and "Vm_A" correspond to "two or more sets among the plurality of sets".

In addition, "Ink_A" included in the usage condition information JI_b3 corresponds to a "first item value", and "Head_B" corresponds to a "second item value". When "Head_D", which is not included in the usage condition information JI_b3, corresponds to a "third item value", the extraction condition CN_b31 corresponds to "a first condition including the first item value and the second item value", the records RC1 satisfying the extraction condition CN_b31 correspond to "a set satisfying the first condition", the extraction condition CN_b32 corresponds to "a second condition including the first item value and the third item value", and the records RC1 satisfying extraction condition CN_b32 correspond to "a set satisfying the second condition".

Additionally, the recommendation information RI_b1, the recommendation information RI_b2, and the recommendation information RI_b3 include the character string indicating the type of head. The character string indicating the type of head is an example of "information indicating a type of the ink jet head".

In addition, the usage condition information JI_b3 includes the character string indicating the ejection amount level, which is one of the plurality of "ejection characteristic items". Meanwhile, the recommendation information RI_b2 and recommendation information RI_b3 include the character string indicating the ejection speed level, which is different from the ejection amount level among the plurality of "ejection characteristic items". The character string indicating the ejection amount level and the character string indicating the ejection speed level are examples of "information indicating the ejection characteristic item".

Further, the recommendation information RI_b1 may include the character string for identifying the waveform information "No5". The waveform information is an example of "waveform information indicating a drive waveform".

For example, in the usage condition information JI_b1, the cloud server CS searches, from the records RC1 in which the character string indicating the type of ink is "Ink_A" and the character string indicating the type of head is "Head_B", for a set of an ejection amount level and an ejection speed level with the largest number of users, but the present disclosure is not limited to this. For example, the cloud server CS may search, from the records RC1 in which the character string indicating the type of ink is "Ink_A" and the character string indicating the type of head is "Head_B", for a set of an ejection amount level and an ejection speed level with the highest average value of reliability.

In the usage condition information JI_a2, as shown in FIG. 17, the premise is that the input ink is set to "Ink_A". Since the condition that the input ink is "Ink_A" is the same as the usage condition information JI_b1, setting of the derived head and specification of the ejection amount level and the ejection speed level are the same as in the example of usage condition information JI_b1, and the description thereof will not be repeated. The cloud server CS generates, from the respective item values of the records RC1 having the character string indicating the type of ink "Ink_A", the character string indicating the type of head "Head_B", the character string indicating the ejection amount level "Iw_B", and the character string indicating the ejection speed level "Vm_B", one or more item values not included in the usage condition information JI as the recommendation information RI_a2. For example, as shown in FIG. 17, the cloud server CS generates the recommendation information RI_a2 having the character string indicating the type of ink "Ink_A". Additionally, the cloud server CS may, from the respective item values of the records RC1 having the character string indicating the type of ink "Ink_A", the character string indicating the type of head "Head_B", the character string indicating the ejection amount level "Iw_B", and the character string indicating the ejection speed level "Vm_B", add "Head_B" to the recommendation information RI_a2, or add "Iw_B" and "Vm_B" to the recommendation information RI_a2.

The description returns to FIG. 11. After the end of the processing in step SC42, or after the end of the processing in step SC46, in step SC48, the cloud server CS transmits, to the evaluation apparatus 20_x, the recommendation information RI including the recommended item values that are the derivation results in step SC42 or the derivation results in steps SC44 and SC46. The usage condition indicated by the recommendation information RI is different from the usage condition indicated by the usage condition information JI. The fact that the usage condition indicated by the recommendation information RI is different from the usage condition indicated by the usage condition information JI includes a case where the usage condition indicated by the recommendation information RI is a condition that restricts the usage condition indicated by the usage condition information JI. For example, it is assumed that the usage condition information JI is "Ink_A" and the recommendation information RI is "Head_A". In this assumption, the recommendation information RI means recommending a usage condition in which, when the type of ink is "Ink_A", the type of head is "Head_A". That is, the usage condition indicated by the recommendation information RI can be said to be a usage condition that restricts the type of head relative to the usage condition indicated by the usage condition information JI. As described above, in the present specification, even when the usage condition indicated by the recommendation information RI is a condition that restricts the usage condition indicated by the usage condition information JI, the usage condition indicated by the recommendation information RI is treated as falling within "being different from the usage condition indicated by the usage condition information JI".

After the end of the processing in step SC48, in step SC50, the cloud server CS determines whether or not the user U_x permits update of the history database RD. As specific processing of step SC50, the cloud server CS inquires, to the evaluation apparatus 20_x, whether or not the user U_x permits update of the history database RD. Alternatively, when the usage condition information JI includes permission information indicating whether or not the user U_x permits update of the history database RD, the cloud server CS may execute the processing in step SC50 in accordance with this permission information.

When the determination result of step SC50 is affirmative, the cloud server CS updates the history database RD in step SC52. After the end of the processing in step SC52, the cloud server CS ends the series of processes shown in FIG. 11. When the determination result of step SC50 is negative, the cloud server CS also ends the series of processes shown in FIG. 11.

In the search process shown in FIG. 11, the cloud server CS derives item values corresponding to one or more items among the ejection characteristic, the drive waveform, and the temperature range; however, without deriving the item values corresponding to these items, the cloud server CS may, at a time point at which the processing in step SC32 ends, transmit to the evaluation apparatus 20 the recommendation information RI that uses, as the recommended item value, the character string indicating the derived head, and end the search process shown in FIG. 11.

In addition, in the series of processes shown in FIG. 11, the cloud server CS sets the derived head and then derives the recommended item value corresponding to one or more items among the ejection characteristic, the drive waveform, and the temperature range corresponding to the usage condition information JI, the input ink, and the derived head; however, the present disclosure is not limited to this. For example, the cloud server CS may, without setting the derived head, derive the recommended item value corresponding to one or more items among the ejection characteristic, the drive waveform, and the temperature range corresponding to the usage condition information JI and the input ink.

The description returns to FIG. 9. After the end of the processing in step SC4, in step SC6, the cloud server CS functions as the transmission section 305 and transmits the recommendation information RI to the evaluation apparatus 20_x. When the recommendation information RI includes the character string for identifying the waveform information, the recommendation information RI also includes the waveform information itself. By executing the processing in step SC6, the cloud server CS also functions as the "output section" that outputs the recommendation information RI including one or more recommended item values. After the end of the processing in step SC6, the cloud server CS ends the series of processes shown in FIG. 9.

After the end of the processing in step SJ4, the control circuit 21 waits for a response from the cloud server CS, and in step SJ6, the control circuit 21 functions as the reception section 215 and receives the recommendation information RI from the cloud server CS. After the end of the processing in step SJ6, in step SJ8, the control circuit 21 functions as the recommendation section 217 and recommends the recommendation information RI to the user U_x. Step SJ8 corresponds to a "recommendation step".

As a specific example of the processing in step SJ8, the evaluation apparatus 20_x displays, on the display device 27, an image indicating the recommended item value included in the recommendation information RI. Alternatively, when the recommendation information RI includes the character string for identifying the waveform information, the evaluation apparatus 20_x, under an instruction from the user U_x, may supply to the ink jet head HU the drive signal Com having the drive waveform indicated by the waveform information included in the recommendation information RI. After the end of the processing in step SJ8, the series of processes shown in FIG. 9 ends.

In addition, when recommending to the user U_x the recommendation information RI_b3 shown in FIG. 16, the evaluation apparatus 20_x may recommend the set Un1 and the set Un2 in parallel, or may assign a priority order to the set Un1 and the set Un2 and recommend the set Un1 and the set Un2. As an aspect for assigning a priority order to the set Un1 and the set Un2, for example, the evaluation apparatus 20_x may regard the set Un1 as information matching usage search information of the user U_x and may display, on the display device 27, an image in which the set Un2 is displayed as reference information.

### 1-7. Summary of First Embodiment

Hereinafter, assuming that, among six items relating to the ejection of ink included in the correspondence information CI, one of any two items is denoted as a "first item" and the other item is denoted as a "second item", one or more item values corresponding to the first item are denoted as "first item values", one or more item values corresponding to the second item are denoted as "second item value" and "third item values", and as an example of the "specific user", a user U who operates the evaluation apparatus 20 to input the usage condition information JI is denoted as the user U_x, a summary of the first embodiment will be described.

As described above, the system SYS according to the first embodiment is a system used to eject ink using the ink jet head HU. The system SYS includes the acceptance section 211 and the recommendation section 217. The acceptance section 211 accepts the usage condition information JI indicating the usage condition relating to the ejection of ink, based on operation information by the user U_x. The recommendation section 217 recommends to the user U_x, as the recommendation information RI, a usage condition different from the usage condition indicated by the usage condition information JI accepted by the acceptance section 211, based on the history database RD indicating a history of use by a user U different from the user U_x and the usage condition information JI. Additionally, the first embodiment can also define a usage assistance method for the system SYS that executes step SJ2 corresponding to the "acceptance step" and step SJ8 corresponding to the "recommendation step".

According to the first embodiment, since the history database RD is a history of use by a user U different from the user U_x, the history database RD can be said to be information with a certain level of ensured quality. Therefore, the recommendation information RI is higher in quality than recommendation information generated by application of an automatic algorithm. Further, even when the same information as the usage condition information JI is not registered in the history database RD, the recommendation section 217 may provide, as the recommendation information RI, a history indicating a usage condition close to the usage condition indicated by the usage condition information JI to the user U_x. That is, according to the first embodiment, as compared with an aspect in which the history database RD includes no usage condition that is unknown to the head manufacturer, construction of the history database RD becomes easier. As described above, according to the first embodiment, it is possible to facilitate construction of the history database RD while maintaining high-quality recommendation information RI.

In addition, the history database RD includes a plurality of records RC including, among a plurality of items relating to the ejection of ink, one or more item values corresponding to the first item and one or more item values corresponding to the second item. The usage condition information JI includes at least an item value corresponding to the first item. The recommendation information RI includes at least an item value corresponding to the second item, the item value being included in the same record as the item value corresponding to the first item that is accepted as the usage condition information.

According to the first embodiment, since the record RC1 is a record used by one or more users U, the record can be said to be a record with a certain level of ensured quality. Therefore, the recommended item value according to the first embodiment can be said to be higher in quality than the recommended item value generated by application of the automatic algorithm. In addition, in the first embodiment, the record RC1 having an appropriate item value is retrieved based on one or more item values included in the usage condition information JI. Specifically, the cloud server CS searches for a record RC1 having item values that coincide with or are close to some or all of the one or more item values included in the usage condition information JI. Therefore, in the first embodiment, even when the second item value included in the usage condition information JI is an item value unknown to the head manufacturer and not registered in the correspondence information CI, in a case where an item value close to this unknown second item value is registered in the correspondence information CI, or in a case where the first item value is an item value registered in the correspondence information CI, a record RC1 suitable for the usage condition information JI can be acquired. Accordingly, in the first embodiment, even when the usage condition information JI includes an item value unknown to the head manufacturer, it is possible to provide to the user U_x the recommended item value suitable for the usage condition information JI. That is, according to the first embodiment, as compared with an aspect in which the history database RD includes no item value that is unknown to the head manufacturer, construction of the history database RD becomes easier. As described above, according to the first embodiment, it is possible to facilitate construction of the history database RD while maintaining high-quality recommendation information RI.

Further, the correspondence information CI can specify the number of users using records RC1 including the first item value and the second item value, and the number of users using records RC1 including the first item value and the third item value. Hereinafter, the records RC1 including the first item value and the second item value may be referred to as "records RC1 satisfying the first condition", and the records RC1 including the first item value and the third item value may be referred to as "records RC1 satisfying the second condition". The recommendation section 217 recommends, when the usage condition information JI includes the first item value and the correspondence information CI specifies that the number of users using the records RC1 satisfying the first condition is greater than the number of users using the records RC1 satisfying the second condition, information including the second item value as the recommendation information RI to the user U_x. Excluding the second item value, information that can be included in the recommendation information RI is, for example, information excluding the second item value, among the information included in the records RC1 satisfying the first condition.

It can be said that the larger the number of users U using a record is, the higher the quality of the item values of the record RC is. Accordingly, according to the first embodiment, higher-quality recommendation information RI can be provided to the user U_x.

In addition, the correspondence information CI can specify the average value of reliability of one or more users using the records RC1 satisfying the first condition, and the average value of reliability of one or more users using the records RC1 satisfying the second condition. The recommendation section 217 recommends, when the usage condition information JI includes the first item value and the correspondence information CI specifies that the average value of reliability of one or more users using the records RC1 satisfying the first condition is greater than the average value of reliability of one or more users using the records RC1 satisfying the second condition, information including the second item value as the recommendation information RI to the user U_x.

It can be said that the greater the average value of reliability is, the higher the quality of the item values of the record RC is. Accordingly, according to the first embodiment, higher-quality recommendation information RI can be provided to the user U_x.

Further, as shown in the usage condition information JI_b3 in FIG. 16, the recommendation section 217 may, based on the history database RD and the usage condition information JI, recommend to the user U_x, as the recommendation information RI, information including one or more item values included in each of two or more records RC among the plurality of records RC.

According to the first embodiment, as compared with an aspect in which information including item values included in one record RC is recommended to the user U_x as the recommendation information RI, it is possible to increase recommended item values that can be used by the user U_x.

In addition, as shown in the usage condition information JI_b3 in FIG. 16, when the usage condition information JI includes the first item value and the second item value, the recommendation section 217 may recommend, to the user U_x, as the recommendation information RI, one or more item values included in the records RC1 satisfying the first condition and one or more item values included in the records RC1 satisfying the second condition.

The effect of using the usage condition information JI_b3 will be described. The type of the ink jet head HU suitable for "Ink_A" corresponding to the "first item value" is "Head_D", which is different from "Head_B" input by the user U_x. Therefore, the recommendation section 217 recommends to the user U_x recommended item values corresponding to "Head_B" input by the user U_x and recommended item values corresponding to "Head_D" determined to be suitable for "Ink_A" from the history database RD. By recommending recommended item values corresponding to "Head_B" input by the user U_x, since recommended item values matching the input result of the user U_x can be recommended, as compared with an aspect in which recommended item values corresponding to "Head_B" input by the user U_x are not recommended, recommended item values with higher satisfaction can be recommended. Furthermore, by recommending, from the history database RD, recommended item values corresponding to "Head_D" determined to be suitable for "Ink_A", while reflecting a part of the item values input by the user U_x, recommended item values determined to be suitable for "Ink_A" can be recommended from the history database RD to the user U_x.

Further, the first item included in the usage condition information JI may include the type of ink.

When the user U_x uses the ink jet head HU, the ink to be used is often determined in advance. Accordingly, by the first item included in the usage condition information JI being the type of ink, it is possible to recommend to the user U_x recommended item values suitable for the type of ink determined in advance.

In addition, the one or more item values included in the usage condition information JI may be one or more physical property values of the ink.

As described above, when the user U_x uses the ink jet head HU, the ink to be used is often determined in advance. However, in the history database RD, ink that the user U_x desires to use may not be registered. Therefore, by the user U_x inputting physical property values of the ink that the user U_x desires to use, it is possible to recommend to the user U_x the recommended item values corresponding to ink, among the inks registered in the history database RD, that has physical property values close to the physical property values of the ink that the user U_x desires to use.

In addition, the recommendation section 217 determines, when the usage condition information JI does not include information indicating the type of ink and includes information indicating the viscosity of the ink and information indicating the physical property value excluding the viscosity of the ink, the type of ink with priority given to the information indicating the viscosity of the ink, and recommends information including information indicating the determined type of ink as the recommendation information RI to the user U_x. For example, using an example in which, among six items relating to the ejection of ink, the "first item" is the viscosity of the ink, the "second item" is, among types of physical properties of the ink, a physical property excluding the viscosity, and the "third item" is the type of ink, the description of the summary of the first embodiment will continue. The item values corresponding to the viscosity of the ink include a first viscosity value, a second viscosity value, and a third viscosity value within a range that the viscosity value of the ink can take, the item values corresponding to the type of ink include first ink information indicating a type of first ink and second ink information indicating a type of second ink, an absolute value of a difference between the first viscosity value and the third viscosity value is smaller than an absolute value of a difference between the second viscosity value and the third viscosity value, and the ink table IkT of the history database RD does not include the record RC2 including the third viscosity value and includes the record RC2 including the first viscosity value and the record RC2 including the second viscosity value. The recommendation section 217 recommends, when the usage condition information JI includes the third viscosity value, to the user U_x, as one or more recommended item values, one or more item values included in the record RC2 that includes the first viscosity value close to the third viscosity value.

It can be said that the closer the physical property values of two inks are to each other, the more similar the operations of the two inks at the time of ejection are. Further, it can be said that the operations of the two inks at the time of ejection when the viscosity values of the two inks are close to each other are closer than the operations of the two inks at the time of ejection when physical property values excluding the viscosity of the two inks are close to each other. Accordingly, according to the first embodiment, recommended item values corresponding to ink that is closer to the operation of the ink that the user U_x desires to use at the time of ejection can be recommended to the user U_x.

In addition, it is preferable that the second item is a type of head.

By recommending information indicating the type of head, the user U who is the printer manufacturer can know an ink jet head HU suitable for the ink that the user U_x desires to use.

Further, the first item may be one ejection characteristic among a plurality of ejection characteristics of the ink jet head HU, and the second item may be an ejection characteristic of the ink jet head HU that is different from the ejection characteristic of the first item among the plurality of ejection characteristics.

According to the first embodiment, it is possible to know information indicating an ejection characteristic excluding information indicating the ejection characteristic input by the user U_x.

Additionally, the second item may be a drive waveform to be supplied to the ink jet head HU.

The ejection operation of the ink jet head HU can be changed according to the drive waveform indicated by the waveform information. According to the first embodiment, the evaluation apparatus 20_x can evaluate the drive waveform by a function of observing the ejection state of ink droplets ejected from the ink jet head HU, and the like.

In addition, the second item may be a usage environment of the ink jet head HU.

Even when the type of ink, the type of head, and the drive waveform are the same, the quality of an image formed on the medium PP may differ when the usage environment of the ink jet head HU differs. By causing the recommendation information RI to include information indicating the usage environment, the user U_x can know a usage environment suitable for the usage condition information JI.

Further, the first embodiment can define the server 30 for use in the system used to eject ink using the ink jet head HU. The server 30 includes: the acquisition section that acquires the usage condition information JI indicating the usage conditions of the user U_x relating to the ejection of ink; the search section 303 that searches, based on the history database RD indicating the history used by a user different from the specific user and the usage condition information JI, for the recommendation information RI for recommending to the user U_x a usage condition different from the usage condition indicated by the usage condition information JI; and an output section that outputs the recommendation information RI retrieved by the search section 303.

According to the first embodiment, it is possible to search for high-quality recommendation information RI from the history database RD that is easy to construct.

### 2. Modification Examples

Each embodiment exemplified above can be variously modified. Specific aspects of modification that can be applied to each embodiment described above will be exemplified below. Two or more aspects optionally selected from the following examples can be combined as appropriate insofar as the aspects are not mutually contradictory.

### 2-1. First Modification Example

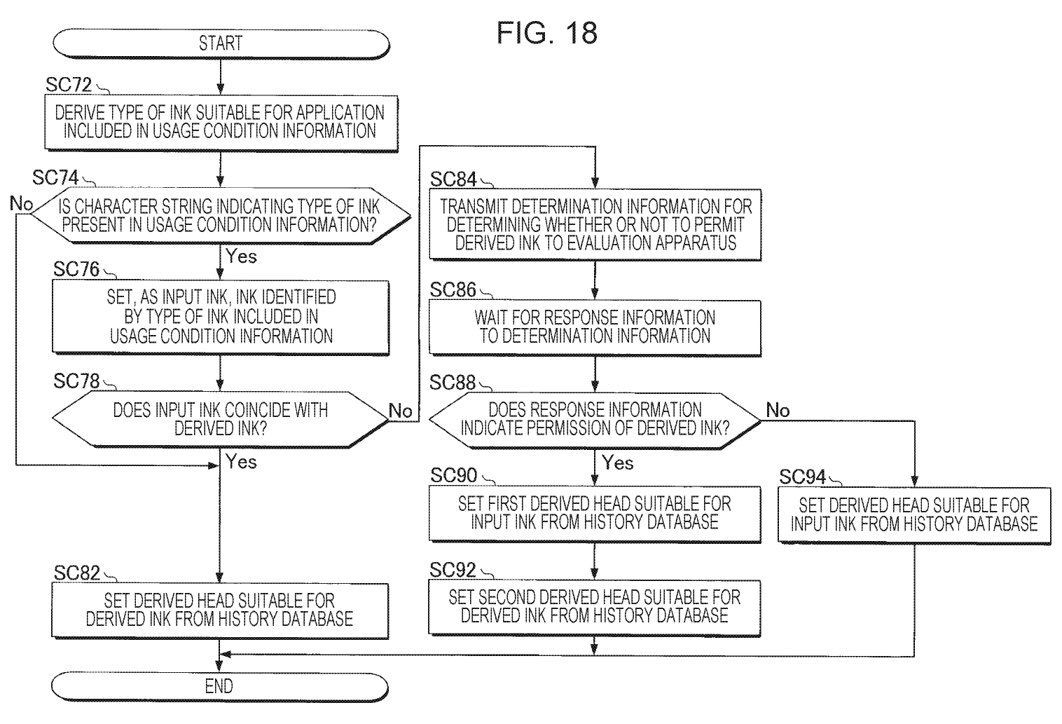

In a first modification example, the recommendation information RI suitable for an application of the ink jet head HU is provided to the user U_x. The first modification example will be described below. In the first modification example, the cloud server CS executes, in place of the input-ink and derived-head setting process shown in FIG. 12, an input-ink and derived-head setting process in the first modification example. The input-ink and derived-head setting process in the first modification example will be described with reference to FIG. 18.

### 2-1-1. Operation of First Modification Example

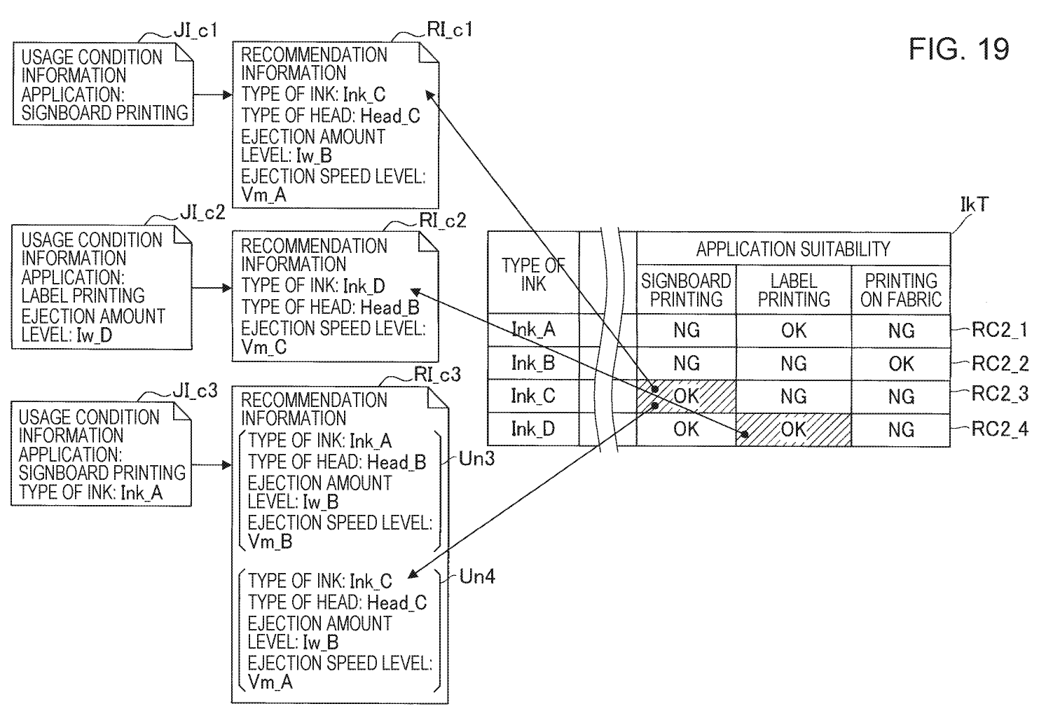

FIG. 18 is a flowchart showing the input-ink and derived-head setting process in the first modification example. In step SC72, the cloud server CS derives a type of ink suitable for the application included in the usage condition information JI. Hereinafter, the ink derived by the processing in step SC72 may be referred to as a "derived ink". The specific setting method for the derived ink will be described below with reference to FIG. 19.

After the end of the processing in step SC72, in step SC74, the cloud server CS determines whether or not the character string indicating the type of ink is present in the usage condition information JI. When the determination result of step SC74 is affirmative, in step SC76, the cloud server CS sets, as the input ink, ink identified by the type of ink included in the usage condition information JI. Next, in step SC78, the cloud server CS determines whether or not the input ink coincides with the derived ink.

When a determination result of step SC78 is affirmative, in step SC82, the cloud server CS sets, from the history database RD, a derived head suitable for the input ink. When the determination result of step SC74 is negative, the cloud server CS also executes the processing in step SC82. After the end of the processing in step SC82, the cloud server CS ends a series of processes shown in FIG. 18.

When the determination result of step SC78 is negative, in step SC84, the cloud server CS transmits, to the evaluation apparatus 20_x, determination information for the user U_x to determine whether or not to permit the derived ink. Next, in step SC86, the cloud server CS waits for response information to the determination information. The response information is either information indicating permission of the derived ink or information indicating non-permission of the derived ink. When the response information is received, in step SC88, the cloud server CS determines whether or not the response information is information indicating permission of the derived ink.

When a determination result of step SC88 is affirmative, in step SC90, the cloud server CS sets, from the history database RD, a first derived head suitable for the input ink. Further, in step SC92, the cloud server CS sets a second derived head suitable for the derived ink. After the end of step SC90, the cloud server CS ends the series of processes shown in FIG. 18. When the cloud server CS ends the series of processes shown in FIG. 18 after the determination result of step SC88 is affirmative, the cloud server CS need only execute, for each of the first derived head and the second derived head, the series of processes shown in FIG. 11. Specifically, the cloud server CS executes steps SC34 to SC46 by replacing the "derived head" with the "first derived head", and further executes steps SC34 to SC46 by replacing the "derived head" with the "second derived head". Then, in step SC48, the cloud server CS need only transmit, to the evaluation apparatus 20, the recommendation information RI including the recommended item values obtained by these two executions of the processing from steps SC34 to SC46.

When the determination result of step SC88 is negative, in other words, when information indicating non-permission of the derived ink is received, in step SC94, the cloud server CS sets, from the history database RD, a derived head suitable for the input ink. After the end of step SC94, the cloud server CS ends the series of processes shown in FIG. 18. FIG. 19 is a diagram illustrating a generation example of the recommendation information RI in the first modification example.

FIG. 19 is a diagram illustrating the generation example of the recommendation information RI in the first modification example. In FIG. 19, as three examples of the usage condition information JI, usage condition information JI_c1, usage condition information JI_c2, and usage condition information JI_c3 are shown. In addition, in FIG. 19, recommendation information RI_c1 generated based on the usage condition information JI_c1, recommendation information RI_c2 generated based on the usage condition information JI_c2, and recommendation information RI_c3 generated based on the usage condition information JI_c3 are shown.

The usage condition information JI_c1 includes only the character string indicating an application in which the ink jet head HU is used, namely "signboard printing". The character string indicating the application in which the ink jet head HU is used is an example of "information indicating an application in which the ink jet head is used". The information indicating the application in which the ink jet head HU is used is not limited to the character string indicating the application in which the ink jet head HU is used and may be, for example, a numerical value indicating the application in which the ink jet head HU is used, an ID, or an icon that visually expresses the application in which the ink jet head HU is used. Additionally, although not shown, in order to cause the usage condition information JI to include the character string indicating the application in which the ink jet head HU is used, the input screen IW in the first modification example has a selection field SF in which the character string indicating the application in which the ink jet head HU is used can be selected.

In the example of the usage condition information JI_c1, the cloud server CS refers to the ink table IkT in step SC72 and sets, as the derived ink, ink suitable for "signboard printing". As understood from FIG. 19, the ink suitable for "signboard printing" is ink identified by "Ink_C" and ink identified by "Ink_D". In step SC72, when the user U_x does not input the character string indicating the type of ink and there are a plurality of inks suitable for the input application, the cloud server CS may set, as the derived ink, any one ink among the plurality of inks suitable for the input application, or may set all of the plurality of inks as the derived ink. Since the usage condition information JI_c1 does not include the character string indicating the type of ink, the cloud server CS sets, in step SC72, the ink identified by "Ink_C" as the derived ink. Subsequently, the cloud server CS executes the processing in step SC82 and the series of processes shown in FIG. 11, and generates recommendation information RI_c1 including, as recommended item values, "Ink_C", "Head_C", "Iw_B", and "Vm_A".

The usage condition information JI_c2 includes the character string indicating the application in which the ink jet head HU is used, namely "label printing", and the character string indicating the ejection amount level, namely "Iw_D". In the example of the usage condition information JI_c2, the cloud server CS refers to the ink table IkT in step SC72 and sets, as the derived ink, ink suitable for "label printing". As understood from FIG. 19, the ink suitable for "label printing" is ink identified by "Ink_A" and ink identified by "Ink_D". Since the usage condition information JI_c2 does not include the character string indicating the type of ink, the cloud server CS sets, in step SC72, the ink identified by "Ink_D" as the derived ink. Subsequently, the cloud server CS executes the processing in step SC82 and the series of processes shown in FIG. 11, and generates the recommendation information RI_c2 including, as recommended item values, "Ink_D", "Head_B", and "Vm_C".

The usage condition information JI_c3 includes the character string indicating the application in which the ink jet head HU is used, namely "signboard printing", and the character string indicating the type of ink, namely "Ink_A". In the example of the usage condition information JI_c3, the cloud server CS refers to the ink table IkT in step SC72 and sets, as the derived ink, ink suitable for "signboard printing". As understood from FIG. 19, the ink suitable for "signboard printing" is ink identified by "Ink_C" and ink identified by "Ink_D", which are different from the ink identified by "Ink_A" included in the usage condition information JI_c3. Therefore, the cloud server CS determines that the determination result of step SC78 is negative. In the example of the usage condition information JI_c3, the premise is that the response information is information indicating permission of the derived ink. Accordingly, in step SC90, the cloud server CS sets, as the first derived head suitable for the input ink "Ink_A", the character string indicating the type of head "Head_B". Subsequently, the cloud server CS executes the series of processes shown in FIG. 11 and generates the recommendation information RI_c3 having, as a set Un3, "Ink_A", "Head_B", "Iw_B", and "Vm_B".

Additionally, in step SC92, the cloud server CS sets, as the second derived head suitable for the derived ink "Ink_C", the character string indicating the type of head "Head_C". Subsequently, the cloud server CS executes the series of processes shown in FIG. 11 and adds, to the recommendation information RI_c3, a set Un4 having "Ink_C", "Head_C", "Iw_B", and "Vm_A".

In the example of the usage condition information JI_c1, "signboard printing" corresponds to "an application in which the ink jet head is used", the character string indicating the type of ink "Ink_C" corresponds to "first ink information", and the character string indicating the type of ink "Ink_A" corresponds to "second ink information". Additionally, in the application suitability information, the character string "OK" indicating that the ink is suitable for signboard printing is an example of "first information", and the character string "NG" indicating that the ink is not suitable for signboard printing is an example of "second information". Further, the record RC2_3 corresponds to "a first set including the first ink information and the first information", and the record RC2_1 corresponds to "a second set including the second ink information and the second information". The "Ink_C" included in the recommendation information RI_c1 corresponds to "first ink information included in a set including the first information among the plurality of sets when the information indicating the application is included in the usage condition information".

In the example of the usage condition information JI_c2, "label printing" corresponds to "the application in which the ink jet head is used", the character string indicating the type of ink "Ink_D" corresponds to "first ink information", and the character string indicating the type of ink "Ink_A" corresponds to "second ink information". Further, in the application suitability information, the character string "OK" indicating that the ink is suitable for label printing is an example of "first information", and the character string "NG" indicating that the ink is not suitable for label printing is an example of "second information". Further, the record RC2_4 corresponds to "a first set including the first ink information and the first information", and the record RC2_2 corresponds to "a second set including the second ink information and the second information". The "Ink_D" included in the recommendation information RI_c2 corresponds to "first ink information included in a set including the first information among the plurality of sets when the information indicating the application is included in the usage condition information".

### 2-1-2. Summary of First Modification Example

In the first modification example, "the second item" is the type of ink, and "the first item" is "the item relating to an application in which the ink jet head is used".

According to the first modification example, it is possible to recommend information regarding ink suitable for an application that the user U_x desires to use.

### 2-2. Second Modification Example

In the first embodiment, as a method of setting the input ink, in step SC28, as an example of determining whether or not two inks are similar, the viscosity among the three physical properties of the ink, namely the density, the viscosity, and the surface tension, is used with the highest priority to determine whether or not the physical property values of the two inks are similar; however, the present disclosure is not limited to this. In a second modification example, in determining whether or not the physical property values of two inks are similar, among the type of solvent and the type of colorant, the type of solvent is prioritized for determination.

### 2-2-1. Operation of Second Modification Example

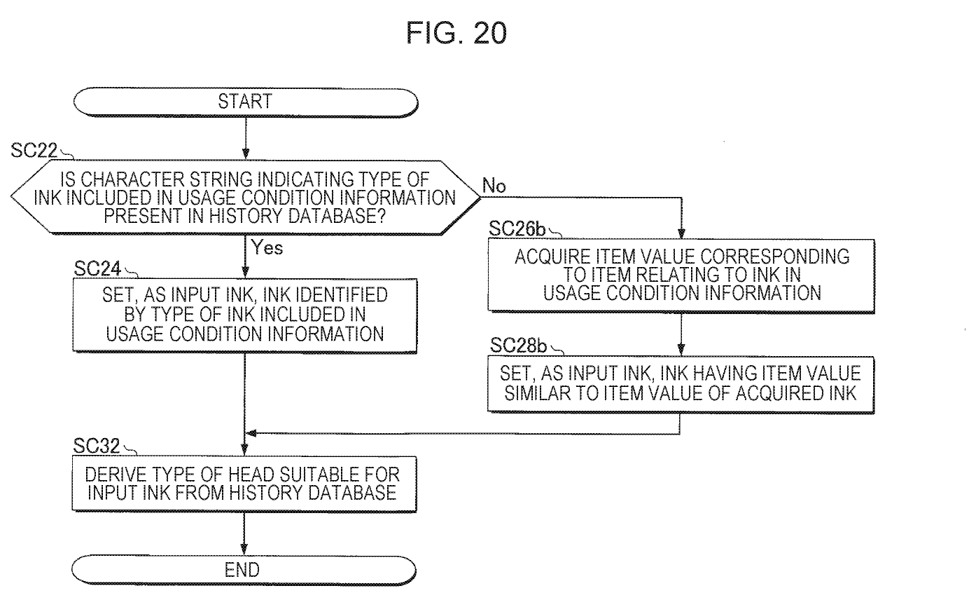

FIG. 20 is a flowchart showing an input-ink and derived-head setting process in the second modification example. The flowchart shown in FIG. 20 is different from the flowchart shown in FIG. 12 in that step SC26b is provided instead of step SC26, and step SC28b is provided instead of step SC28.

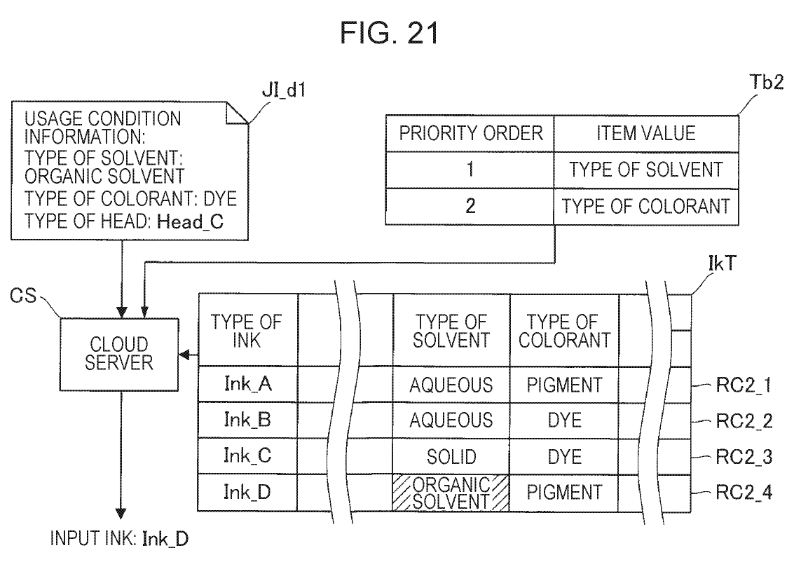

When the determination result of step SC22 is negative, in step SC26b, the cloud server CS acquires an item value corresponding to an item relating to the ink in the usage condition information JI. Hereinafter, the item value of the ink acquired by the processing in step SC26b may be referred to as an "acquired item value". Next, in step SC28b, the cloud server CS sets, as the input ink, ink having an item value similar to the acquired item value. After the end of the processing in step SC28b, the cloud server CS executes the processing in step SC32. The processing in step SC28b will be described with reference to FIG. 21.

FIG. 21 is a diagram illustrating the processing in step SC28b. In FIG. 21, usage condition information JI_d1 is shown as an example of the usage condition information JI. In the processing in step SC28b, the cloud server CS determines, in accordance with a table Tb2 shown in FIG. 21, ink having an item value similar to the acquired item value. The table Tb2 indicates that, for determining whether or not the item values of two inks are similar, among two items of the ink, namely the type of solvent and the type of colorant, the type of solvent is used with the highest priority, and the type of colorant is used with the next priority. Specifically, in step SC28b, as a comparison process for the type of solvent, the cloud server CS determines whether or not, among one or more registered inks registered in the ink table IkT, there is a registered ink having the same type of solvent as the acquired type of solvent. When there is one registered ink having the same type of solvent as the acquired type of solvent, the cloud server CS sets this registered ink as the input ink. When there is no registered ink having the same type of solvent as the acquired type of solvent, the cloud server CS executes, as will be described below, a comparison process for the type of colorant. Additionally, when there are two or more registered inks having the same type of solvent as the acquired type of solvent, the cloud server CS executes the comparison process for the type of colorant on these two or more registered inks. Note that even when the acquired item value does not include the character string indicating the type of solvent, the cloud server CS executes the comparison process for the type of colorant.

When the conditions described above are satisfied, as the comparison process for the type of colorant, the cloud server CS determines whether or not, among one or more registered inks registered in the ink table IkT, there is a registered ink having the same type of colorant as the acquired type of colorant. However, when there are two or more registered inks having the same type of solvent as the acquired type of solvent, the cloud server CS determines whether or not, among these two or more registered inks, there is a registered ink having the same type of colorant as the acquired type of colorant. When there is a registered ink having the same type of colorant as the acquired type of colorant, the cloud server CS sets this registered ink as the input ink. When, among one or more registered inks, there is no registered ink having the same type of colorant as the acquired type of colorant, or when the acquired item value does not include the character string indicating the type of colorant, the cloud server CS may end the series of processes shown in FIGS. 9, 11, and 20 because there is no ink having an item value similar to the item value of the ink acquired by the processing in step SC28b. The cloud server CS may cause the user U_x to select, from the one or more registered inks, ink that the user U_x considers to be similar to the ink for which the item value is acquired by the processing in step SC26b.

The usage condition information JI_d1 illustrated in FIG. 21 includes the character string indicating the type of solvent "organic solvent", the character string indicating the type of colorant "dye", and the character string indicating the type of head "Head_C". In the ink table IkT, there is no record RC2 having both "organic solvent" and "dye". In step SC28b, as the comparison process for the type of solvent, the cloud server CS sets, as the input ink, one registered ink "Ink_D", among four registered inks registered in the ink table IkT, that has the same type of solvent as the acquired type of solvent.

In the example of the usage condition information JI_d1, the type of solvent of the ink corresponds to a "first item", and the type of colorant of the ink corresponds to a "second item", and also corresponds to "an item excluding the type of solvent of the ink". "Organic solvent" corresponds to "first solvent information that the type of solvent of the ink can take", and "aqueous" corresponds to "second solvent information that the type of solvent of the ink can take". "Dye" and "pigment" correspond to "item values corresponding to the second item", "dye" corresponds to a "second item value", and "pigment" corresponds to a "third item value". The record RC2_4 corresponds to "a set having the first solvent information and the third item value", and the record RC2_2 corresponds to "a set having the second solvent information and the second item value". "Ink_D" set as the input ink corresponds to "one or more recommended item values".

### 2-2-2. Summary of Second Modification Example

The recommendation section 217, when the usage condition information JI accepted by the acceptance section 211 does not include information indicating the type of ink and includes information indicating the solvent of the ink and item values corresponding to an item excluding the solvent of the ink, determines the type of ink with priority given to the information indicating the solvent of the ink, and recommends, to the user U_x, as the recommendation information RI, information including information indicating the determined type of ink. Specifically, using "the first item" denoted as the type of solvent of the ink, and "the second item" denoted as the type of colorant of the ink, the summary of the second modification example will be described. The item values corresponding to the type of solvent of the ink include first solvent information and second solvent information that the type of solvent of the ink can take, the item values corresponding to the second item include the second item value and the third item value, and the ink table IkT does not include a set including the first solvent information and the second item value, and includes a set having the first solvent information and the third item value and a set having the second solvent information and the second item value. In the second modification example, when the usage condition information JI includes the first solvent information and the second item value, the recommendation section 217 recommends, to the user U_x, as one or more recommended item values, one or more item values included in the record RC2 that satisfies a condition having the first solvent information.

According to the second modification example, when the types of solvent of two inks are the same, it can be said that the operations of the two inks at the time of ejection are more similar as compared with when the item values corresponding to items excluding the solvent for the two inks are the same. Accordingly, according to the second modification example, recommended item values corresponding to ink that is closer to the operation of the ink that the user U_x desires to use at the time of ejection can be recommended to the user U_x.

### 2-3. Third Modification Example

The correspondence information CI in the first embodiment includes the character string for identifying the waveform information; however, instead of or in addition to the character string for identifying the waveform information, information regarding image processing parameters used for image processing when ink is ejected from the ink jet head HU may be included.

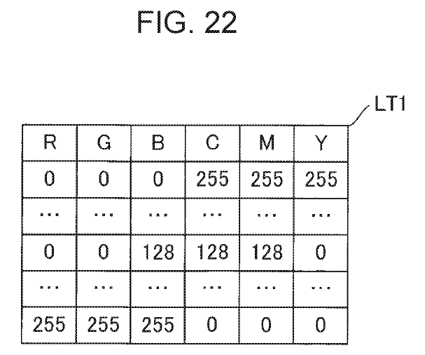

FIG. 22 is a diagram showing an example of the image processing parameter. In FIG. 22, a lookup table LT1 is shown as an example of the image processing parameter. The image processing includes color conversion processing and RIP processing. RIP is an abbreviation for "raster image processor". The color conversion processing is processing of converting RGB values expressed by file format image data into CMYK values or CMY values, which are the ink colors used by the ink jet printer 10, with reference to the lookup table LT1. The lookup table LT1 shown in FIG. 22 shows an example of conversion to CMY values. The RIP processing is processing of generating the print data Img, which is data printable by the ink jet printer 10, by using information indicating a dither pattern and information indicating an error diffusion matrix. The image processing is executed by a host computer that supplies the print data Img to the ink jet printer 10. However, the image processing may be executed by the ink jet printer 10. In addition, the evaluation apparatus 20 may generate the print data Img by executing the image processing on file format image data. The image processing parameter is not limited to the lookup table, and may be the information indicating a dither pattern and the information indicating an error diffusion matrix described above, or may be a mask pattern for distributing the print data Img to a plurality of ink jet heads HU or passes, or the like.

In the above third modification example, among the items relating to the ejection of ink, which are included in the correspondence information CI, when one of any two items is set as "the first item" and the other item is set as "the second item", the second item is the image processing parameter used for image processing when ink is ejected from the ink jet head HU.

The image formed by the ink jet head HU is changeable according to the image processing parameter. According to the third modification example, by forming an image on the medium PP using the print data Img converted using the image processing parameter, the evaluation apparatus 20_x can evaluate the image processing parameter by a function of observing how ink droplets land on the medium PP, and the like.

### 2-4. Fourth Modification Example

In the above-described aspects, the server 30 functioning as the cloud server CS functions as the search section 303; however, the evaluation apparatus 20 may function as the search section 303.

### 2-5. Fifth Modification Example

In each aspect described above, a serial type ink jet printer 10 in which the ink jet head HU reciprocates in the direction along the X-axis is exemplified, but the present disclosure is not limited to such an aspect. The ink jet printer 10 may be a line type liquid ejection apparatus in which a plurality of nozzles Nz are distributed over the entire width of the medium PP.

### 2-6. Other Modification Examples

The ink jet printer 10 described above can be employed in various apparatuses such as a facsimile apparatus and a copier in addition to an apparatus dedicated to printing. Moreover, applications of a recording apparatus of the present disclosure are not limited to printing. For example, a recording apparatus that ejects a solution of a colorant is utilized as a manufacturing apparatus that forms a color filter of a liquid-crystal display apparatus. Additionally, a recording apparatus that ejects a solution of a conductive material is utilized as a manufacturing apparatus that forms wiring and electrodes of a wiring substrate.

What is claimed is:

1. A system used to eject ink using an ink jet head, the system comprising:
an acceptance section that accepts usage condition information indicating a usage condition relating to ejection of ink, based on operation information by a specific user; and
a recommendation section that recommends, based on history information indicating a history of use by a user different from the specific user and the usage condition information, to the specific user, as recommendation information, a usage condition different from the usage condition indicated by the usage condition information accepted by the acceptance section.

2. The system according to claim 1, wherein
the history information includes a plurality of sets that include, among a plurality of items relating to the ejection of ink, one or more item values corresponding to a first item and one or more item values corresponding to a second item,
the usage condition information includes at least an item value corresponding to the first item, and
the recommendation information includes at least an item value corresponding to the second item, the item value being included in the same set as the item value corresponding to the first item that is accepted as the usage condition information.

3. The system according to claim 2, wherein
the one or more item values corresponding to the first item include a first item value,
the one or more item values corresponding to the second item include a second item value and a third item value,
the history information specifies the number of users using a set satisfying a first condition having the first item value and the second item value, and the number of users using a set satisfying a second condition having the first item value and the third item value, and
the recommendation section
recommends, when the usage condition information includes the first item value and the history information specifies that the number of users using the set satisfying the first condition is greater than the number of users using the set satisfying the second condition, information including the second item value as the recommendation information to the specific user.

4. The system according to claim 2, wherein
the item value corresponding to the first item includes a first item value,
the item value corresponding to the second item includes a second item value and a third item value,
the history information specifies a representative value of reliability for one or more users using a set satisfying a first condition having the first item value and the second item value and a representative value of reliability for one or more users using a set satisfying a second condition having the first item value and the third item value, and
the recommendation section
recommends, when the usage condition information includes the first item value and the history information specifies that the representative value of reliability for the one or more users using the set satisfying the first condition is greater than the representative value of reliability for the one or more users using the set satisfying the second condition, information including the second item value as the recommendation information to the specific user.

5. The system according to claim 2, wherein
the recommendation section recommends, based on the history information and the usage condition information, to the specific user, as the recommendation information, information including one or more item values included in each of two or more sets among the plurality of sets.

6. The system according to claim 2, wherein
the item value corresponding to the first item includes a first item value,
the item value corresponding to the second item includes a second item value and a third item value,
the history information includes a set satisfying a first condition having the first item value and the second item value, and a set satisfying a second condition having the first item value and the third item value, and
the recommendation section
recommends, when the usage condition information includes the first item value and the second item value, information including the second item value and information including the third item value as the recommendation information to the specific user.

7. The system according to claim 2, wherein
the first item is a type of ink.

8. The system according to claim 2, wherein
the recommendation section
determines, when the usage condition information accepted by the acceptance section does not include information indicating a type of ink and includes information indicating a viscosity of the ink and information indicating a physical property value excluding the viscosity of the ink, the type of ink with priority given to the information indicating the viscosity of the ink, and
recommends information including information indicating the determined type of ink as the recommendation information to the specific user.

9. The system according to claim 2, wherein
the recommendation section
determines, when the usage condition information accepted by the acceptance section does not include information indicating a type of ink and includes information indicating a solvent of the ink and an item value corresponding to an item excluding the solvent of the ink, the type of ink with priority given to the information indicating the solvent of the ink, and
recommends information including information indicating the determined type of ink as the recommendation information to the specific user.

10. The system according to claim 7, wherein
the second item is a type of the ink jet head.

11. The system according to claim 7, wherein
the first item is one ejection characteristic among a plurality of ejection characteristics of the ink jet head, and
the second item is an ejection characteristic of the ink jet head that is different from the ejection characteristic of the first item among the plurality of ejection characteristics.

12. The system according to claim 7, wherein
the second item is a drive waveform to be supplied to the ink jet head.

13. The system according to claim 7, wherein
the second item is a usage environment of the ink jet head.

14. The system according to claim 7, wherein
the second item is an image processing parameter used for image processing when ink is ejected from the ink jet head.

15. The system according to claim 2, wherein
the second item is a type of ink, and
the first item is an item relating to an application in which the ink jet head is used.

16. The system according to claim 1, further comprising:
a search section that searches for the recommendation information based on the history information and the usage condition information, wherein
the recommendation section recommends, to the specific user, the recommendation information retrieved by the search section.

17. A usage assistance method for a system used to eject ink using an ink jet head, the usage assistance method comprising:
an acceptance step of accepting usage condition information indicating a usage condition relating to ejection of ink, based on operation information by a specific user; and
a recommendation step of recommending, based on history information indicating a history of use by a user different from the specific user and the usage condition information, to the specific user, as recommendation information, a usage condition different from the usage condition indicated by the usage condition information accepted in the acceptance step.

18. A server for use in a system used to eject ink using an ink jet head, the server comprising:
an acquisition section that acquires usage condition information indicating a usage condition of a specific user relating to ejection of ink;
a search section that searches, based on history information indicating a history of use by a user different from the specific user and the usage condition information, for recommendation information for recommending to the specific user a usage condition different from the usage condition indicated by the usage condition information; and
an output section that outputs the recommendation information retrieved by the search section.
